(19) United States
(12) Patent Application Publication
(10) Pub. No.: US 2015/0103925 A1
(43) Pub. Date: Apr. 16, 2015

(54) PARALLEL EXTENSIONS OF PARAMETER SETS

(71) Applicant: QUALCOMM Incorporated, San Diego, CA (US)

(72) Inventors: Ying Chen, San Diego, CA (US); Ye-Kui Wang, San Diego, CA (US)

(21) Appl. No.: 14/514,007

(22) Filed: Oct. 14, 2014

Related U.S. Application Data
(60) Provisional application No. 61/891,302, filed on Oct. 15, 2013.

(51) Int. Cl. H04N 19/463; H04N 19/70

(52) U.S. Cl. CPC H04N 19/00551; H04N 19/00884
USPC 375/240.26

(57) ABSTRACT

An example method of decoding video data includes receiving encoded video data representing a parameter set, and receiving, in the encoded video data, a syntax element indicating whether the parameter set includes two or more extension syntax structures. The method may further include, in the case that the syntax element indicates that the parameter set includes the two or more extension syntax structures, receiving a corresponding syntax element for each of two or more corresponding coding modes, where the corresponding syntax element indicates whether or not the parameter set includes a respective extension syntax structure for the corresponding coding mode, and decoding the encoded video data corresponding to the parameter set.

This application claims the benefit of U.S. Provisional Application No. 61/891,302, filed Oct. 15, 2013, the entire contents each of which are incorporated by reference herein.

### TECHNICAL FIELD

This disclosure relates to video coding.

### BACKGROUND

Digital video capabilities can be incorporated into a wide range of devices, including digital televisions, digital direct broadcast systems, wireless broadcast systems, personal digital assistants (PDAs), laptop or desktop computers, tablet computers, e-book readers, digital cameras, digital recording devices, digital media players, video gaming devices, video game consoles, cellular or satellite radio telephones, so-called “smart phones,” video teleconferencing devices, video streaming devices, and the like. Digital video devices implement video coding techniques, such as those described in the standards defined by MPEG-2, MPEG-4, ITU-T H.263, ITU-T H.264/MPEG-4, Part 10, Advanced Video Coding (AVC), the High Efficiency Video Coding (HEVC) standard presently under development, and extensions of such standards. The video devices may transmit, receive, encode, decode, and/or store digital video information more efficiently by implementing such video coding techniques.

Video coding techniques include spatial (intra-picture) prediction and/or temporal (inter-picture) prediction to reduce or remove redundancy inherent in video sequences. For block-based video coding, a video slice (e.g., a video frame or a portion of a video frame) may be partitioned into video blocks, which may also be referred to as treeblocks, coding units (CUs) and/or coding nodes. Video blocks in an intra-coded (I) slice of a picture are encoded using spatial prediction with respect to reference samples in neighboring blocks in the same picture. Video blocks in an inter-coded (P or B) slice of a picture may use spatial prediction with respect to reference samples in neighboring blocks in the same picture or temporal prediction with respect to reference samples in other reference pictures. Pictures may be referred to as frames, and reference pictures may be referred to a reference frames.

Spatial or temporal prediction results in a predictive block for a block to be coded. Residual data represents pixel differences between the original block to be coded and the predictive block. An inter-coded block is encoded according to a motion vector that points to a block of reference samples forming the predictive block, and the residual data indicating the difference between the coded block and the predictive block. An intra-coded block is encoded according to an intra-coding mode and the residual data. For further compression, the residual data may be transformed from the pixel domain to a transform domain, resulting in residual transform coefficients, which then may be quantized. The quantized transform coefficients, initially arranged in a two-dimensional array, may be scanned in order to produce a one-dimensional vector of transform coefficients, and entropy coding may be applied to achieve even more compression.

### SUMMARY

In general, this disclosure describes video coding techniques. In various examples of this disclosure, the techniques are directed to parallel extensions for a parameter set, such as one or more of a sequence parameter set (SPS), a picture parameter set (PPS), a video parameter set (VPS), etc.

In one example, this disclosure describes a method of decoding video data. In this example, the method includes receiving encoded video data representing a parameter set, and receiving, in the encoded video data, a syntax element indicating whether the parameter set includes two or more extension syntax structures. The method may further include, in the case that the syntax element indicates that the parameter set includes the two or more extension syntax structures, receiving a corresponding syntax element for each of two or more corresponding coding modes, where the corresponding syntax element indicates whether or not the parameter set includes a respective extension syntax structure for the corresponding coding mode, and decoding the encoded video data corresponding to the parameter set.

In another example, this disclosure describes a method of encoding video data. In this example, the method includes encoding a syntax element to indicate whether a parameter set includes two or more extension syntax structures, and in the case that the syntax element indicates that the parameter set includes the two or more extension syntax structures, encoding a corresponding syntax element for each of two or more corresponding coding modes, where the corresponding syntax element indicates whether or not the parameter set includes a respective extension syntax structure for the corresponding coding mode. The method further includes signaling encoded video data corresponding to the parameter set in an encoded video bitstream.

In another example, this disclosure is directed to a device for coding video data. In this example, the device includes a memory and one or more processors. The processor(s) may be configured to receive encoded video data representing a parameter set, and to receive, in the encoded video data, a syntax element indicating whether the parameter set includes two or more extension syntax structures. The processor(s) may be further configured to receive, in the case that the syntax element indicates that the parameter set includes the two or more extension syntax structures, a corresponding syntax element for each of two or more corresponding coding modes, where the corresponding syntax element indicates whether or not the parameter set includes a respective extension syntax structure for the corresponding coding mode, and to decode the encoded video data corresponding to the parameter set.

In another example, this disclosure describes a non-transitory computer-readable storage medium encoded with instructions. The instructions, when executed, cause one or more processors of a video coding device to receive encoded video data representing a parameter set, and to receive, in the encoded video data, a syntax element indicating whether the parameter set includes two or more extension syntax structures. The instructions, when executed may further cause the processor(s) of the video coding device to receive, in the case that the syntax element indicates that the parameter set includes the two or more extension syntax structures, a corresponding syntax element for each of two or more corresponding coding modes, where the corresponding syntax element indicates whether or not the parameter set includes a respective extension syntax structure for the corresponding coding mode, and to decode the encoded video data corresponding to the parameter set.

In another example, this disclosure describes an apparatus for coding video data. The apparatus includes means for receiving encoded video data representing a parameter set, and means for receiving, in the encoded video data, a syntax element indicating whether the parameter set includes two or more extension syntax structures. The apparatus may further include means for receiving, in the case that the syntax element indicates that the parameter set includes the two or more extension syntax structures, a corresponding syntax element for each of two or more corresponding coding modes, where the corresponding syntax element indicates whether or not the parameter set includes a respective extension syntax structure for the corresponding coding mode, and means for decoding the encoded video data corresponding to the parameter set.

This disclosure also describes devices for performing various operations (e.g., of various methods described herein) including video encoders configured to perform the methods, video decoders configured to perform the methods, and devices having means for performing the methods, as well as computer-readable media comprising instructions to cause one or more processors to perform the methods.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example video encoding and decoding system that may be configured to implement one or more techniques described in this disclosure.

FIG. 2 is a block diagram illustrating an example of a video encoder that may be configured to implement one or more techniques described in this disclosure.

FIG. 3 is a block diagram illustrating an example of a video decoder that may be configured to implement one or more techniques described in this disclosure.

FIG. 4 is a flowchart illustrating an example process that a video decoder may perform to support multiple parallel extensions for a parameter set, in accordance with one or more aspects of this disclosure.

FIG. 5 is a flowchart illustrating an example process that a video encoder may perform to support multiple parallel extensions for a parameter set, in accordance with one or more aspects of this disclosure.

### DETAILED DESCRIPTION

Video coding standards include ITU-T H.261, ISO/IEC MPEG-1 Visual, ITU-T H.262 or ISO/IEC MPEG-2 Visual, ITU-T H.263, ISO/IEC MPEG-4 Visual and ITU-T H.264 (also known as ISO/IEC MPEG-4 AVC), including its Scalable Video Coding (SVC) and Multiview Video Coding (MVC) extensions.

Recently, the design of a new video coding standard, namely High-Efficiency Video Coding (HEVC), has been finalized by the Joint Collaboration Team on Video Coding (JCT-VC) of ITU-T Video Coding Experts Group (VCEG) and ISO/IEC Motion Picture Experts Group (MPEG). The latest HEVC draft specification, referred to as “HEVC WD” hereinafter, is available from http://phenix.int-evry.fr/jct/doc_end_user/documents/14_Vienna/wg11/JCTVC-N1003-v1.zip. The multiview extension to HEVC, referred to as “MV-HEVC” for the remainder of this disclosure, is also being developed by the JCT-3V. A recent Working Draft (WD) of MV-HEVC, referred to as “MV-HEVC WD5” hereinafter, is available from http://phenix.it-sudparis.eu/jct2/doc_end_user/documents/5_Vienna/wg11/JCT3V-E1004-v6.zip. The scalable extension to HEVC, referred to as “SHVC” for the remainder of this disclosure, is also being developed by the JCT-VC. A recent Working Draft (WD) of SHVC and referred to as SHVC WD3 hereinafter, is available from http://phenix.it-sudparis.eu/jct/doc_end_user/documents/14_Vienna/wg11/JCTVC-N1008-v3.zip. A recent working draft (WD) of the range extension of HEVC, referred to as “range extension” for the remainder of this disclosure, is available from http://phenix.int-evry.fr/jct/doc_end_user/documents/14_Vienna/wg11/JCTVC-N1005-v3.zip.

According to HEVC, a video coding device may use one or more of video, sequence, picture and adaptation parameter sets (VPS, SPS, PPS, and APS) to decouple the transmission of infrequently changing information from the transmission of coded block data. A VPS may be defined as a syntax structure containing syntax elements that apply to zero or more entire CVSs as determined by the content of a syntax element found in the SPS referred to by a syntax element found in the PPS referred to by a syntax element found in each slice segment header. An SPS may be defined as a syntax structure containing syntax elements that apply to zero or more entire CVSs as determined by the content of a syntax element found in the PPS referred to by a syntax element found in each slice segment header. A PPS may be defined as a syntax structure containing syntax elements that apply to zero or more entire coded pictures as determined by a syntax element found in each slice segment header.

For instance, in some implementations, the video coding device may convey one or more of the VPS, SPS, PPS, and APS “out-of-band.” In other words, according to such implementations, the video coding device may not signal one or more of the VPS, SPS, PPS, and APS together with network abstraction layer (NAL) units that include encoded video data. Additionally, out-of-band transmission is often more reliable (e.g., error-resistant or error-resilient) than in-band transmission.

Additionally, the video coding device may code each individual picture on a slice-by-slice basis, such that different slices of a single picture may be of equal or different lengths (e.g., expressed as respective numbers of blocks in each slice). In turn, the video coding device may associate each slice with a corresponding slice header. Similarly to the various parameter sets described above, a slice header may include syntax elements that apply to all blocks of the corresponding slice. In turn, the video coding device may determine that a NAL unit includes video data corresponding to one or more slices of a picture, separated by slice header information included in the NAL unit.

According to the HEVC specification, each slice header includes a PPS identification (ID) and, optionally, an APS ID. In other words, each slice header may reference the PPS for the picture to which the corresponding slice belongs. Additionally, each slice header may, in some scenarios, reference the APS for the picture to which the corresponding slice belongs. Earlier video coding standards included techniques by which a video coding device may determine various parameters that are common across the picture-level. As one example, according to the audio-visual coding standard for the mobile multimedia application (AVS-M) standard, a picture header NAL unit included those picture-level parameters that must be the same for all slices of a picture, but are not included in the PPS corresponding to the picture.

According to HEVC, a video encoding device may set a syntax element to a “true” value to indicate that a parameter set includes extension syntax elements or syntax structures. Extension syntax structures may be defined by one or more extensions to HEVC. In some examples, in accordance with HEVC, the video encoding device may signal the syntax element as a flag set to a value of 1 for “true” to indicate that the parameter set includes one or more extension syntax structures. Some parameter sets may include extension syntax structures defined by multiple extensions to HEVC, (e.g., an “existing” extension to HEVC and a “subsequent” extension HEVC). In scenarios where a subsequent HEVC extension is implemented as an addition to an existing HEVC extension, the video encoding and decoding devices may be required to process bits defined by the existing HEVC extension in all cases where the parameter set includes any syntax structure defined by the subsequent HEVC extension.

This disclosure describes various video coding techniques that process parameter set extensions defined by different HEVC extensions independently of one another. At various points of this disclosure, video coding devices are described as supporting “parallel” extensions of a parameter set with respect to processing the different parameter set extensions independently of one another. Additionally, video coding devices may support parallel extensions for various types of parameters sets, including sequence parameter sets (SPSs) and parallel picture parameter sets (PPSs). Supported parallel HEVC extensions may include any one or more of a range extension to HEVC, a multiview extension to HEVC (“MV-HEVC”), a scalable extension to HEVC (“SHVC”). More specifically, video coding devices may implement various techniques of this disclosure to support parameter sets defined by two or more of the range extension, MV-HEVC, or SHVC in parallel. At various points of this disclosure, the range extension, MV-HEVC, and SHVC may be referred to “coding modes.”

Each of the range extension, MV-HEVC, and SHVC may be implemented as an amendment to HEVC. For example, the range extension may form a first amendment (or “amendment 1”) to HEVC, MV-HEVC may form a second amendment (or “amendment 2”) to HEVC, and SHVC may form a third amendment (or “amendment 3”) to HEVC. According to this scenario, MV-HEVC may be implemented as a subsequent amendment to the range extension. According to this scenario, MV-HEVC may be “built on top of” the range extension, when described in terms of syntax structure. In other words, to process syntax elements defined by MV-HEVC, a video coding device may be required to process additional syntax elements defined by the range extension.

However, in several instances, features of MV-HEVC may not require one or more features of the range extension. For instance, in such cases, to decode syntax elements provided by MV-HEVC, a video decoder, may not require one or more syntax elements provided by the range extension. In one such example, to decode a parameter set that includes extension syntax structures defined by MV-HEVC, the video decoder may not require any syntax structures defined by the range extension. In other words, to decode various MV-HEVC-defined parameter set extensions, the video decoder may not require any range extension-defined parameter set extensions to be “on” with respect to the same parameter set. Consequently, in decoding various parameter set extensions defined by MV-HEVC, the video decoder may not require a video encoder to signal, or may not need to decode, any parameter set extensions defined by the range extension, with respect to the same parameter set.

Similarly, SHVC may be built on top of MV-HEVC, in terms of syntax structure. In other words, parameter set extensions defined by SHVC may be additional extensions of parameter set extensions defined by MV-HEVC, in terms of syntax structure. Thus, to decode certain parameter set extensions defined by SHVC, the video decoder may not any parameter set extensions defined by the range extension (with respect to the same parameter set). In various scenarios described herein, parameter extensions defined by MV-HEVC may still be necessary for the video decoder to decode various parameter set extensions defined by SHVC, for the same parameter set.

The techniques of this disclosure are generally directed to supporting multiple parameter set extensions “in parallel” for a given parameter set. For instance, a video coding device may implement one or more of the techniques to support two parameter set extensions, one defined by the range extension and the other defined by MV-HEVC, in parallel for a single parameter set. With respect to this example, the respective parameter set extensions defined by MV-HEVC and the range extension may be referred to herein as “parallel extensions” of the parameter set. By supporting multiple parallel extensions for a single parameter set, the video coding device may implement the techniques of this disclosure to process the parameter set extensions independently of one another, regardless of which HEVC extension defines each parameter set extension syntax structure.

According to various aspects of this disclosure, the video decoder may use an extension syntax element (e.g., a flag) to determine whether a parameter set (e.g., an SPS, a PPS, etc.) includes any parameter extensions. More specifically, the video decoder may use the flag to determine whether the parameter set includes any parameter set extensions, regardless of which HEVC extension (e.g., the range extension, MV-HEVC, or SHVC) defines any such parameter set extensions. In turn, if the video decoder determines that the parameter set includes any parameter set extensions, the video decoder may use one or more additional flags to determine which HEVC extension define the included parameter set extension(s). In this manner, the video decoder may implement the techniques described herein to process parameter set extensions defined by the range extension as parallel extension syntax structures to parameter set extensions defined by MV-HEVC and/or SHVC.

By treating parameter set extensions defined by MV-HEVC and/or SHVC as parallel extensions to parameter set extensions defined by the range extension to HEVC, a video coding device may implement one or more techniques of this disclosure to improve signaling efficiency and/or conserve computing resources. For example, by processing the range extension-defined parameter set extension(s) as parallel extensions to the one or more parameter set extensions defined by MV-HEVC and/or SHVC, a video decoder may conserve computing resources by using extension flag values to determine whether a parameter set includes any extensions at all, before decoding any syntax elements that indicate which HEVC extension(s) may define each included parameter set extension syntax structure. Additionally, by supporting multiple parallel parameter set extensions, a video encoder may signal a flag to indicate whether a parameter set includes any extension syntax structures. In this example, if the flag is disabled, the video encoder may not signal any further syntax elements to indicate the which HEVC extension(s) are applied, thereby improving signaling efficiency and reducing bandwidth consumption. In this manner, the techniques described herein may enable both video decoders and video encoders to improve video processing efficiency, while maintaining picture quality.

Various techniques described herein may be performed by a variety of video coding devices, such as video encoders and/or video decoders. In addition, such methods could be performed in other devices, such as transcoders, media aware network elements (MANEs), or the like. In this disclosure, the techniques will be described with respect to video encoders and decoders, for purposes of illustration.

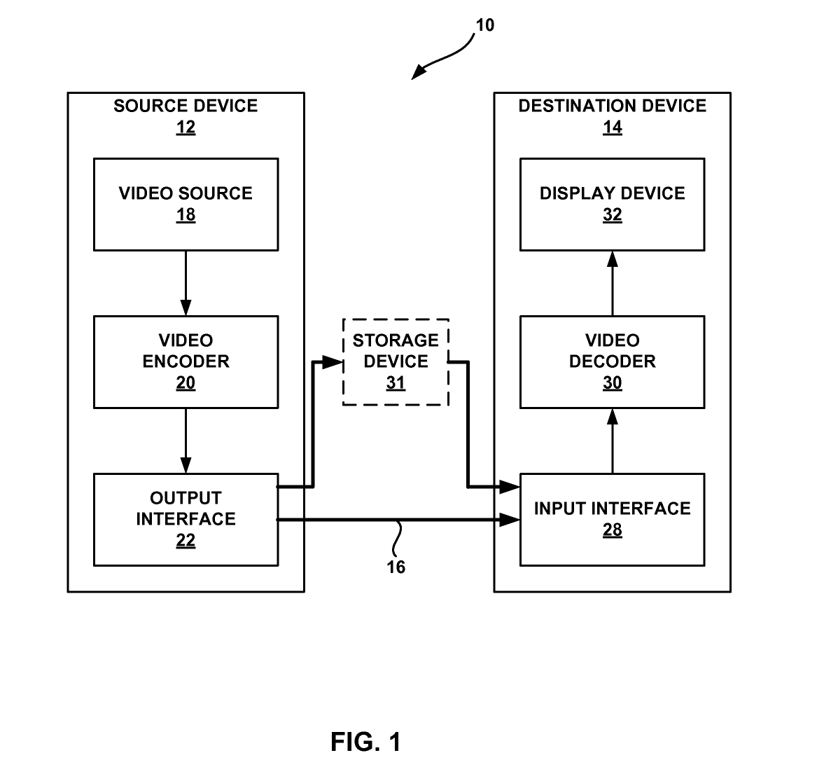

FIG. 1 is a block diagram illustrating an example video encoding and decoding system 10 that may utilize the techniques described in this disclosure. As shown in FIG. 1, system 10 includes a source device 12 that generates encoded video data to be decoded at a later time by a destination device 14. Source device 12 and destination device 14 may comprise any of a wide range of devices, including desktop computers, notebook (i.e., laptop) computers, tablet computers, set-top boxes, telephone handsets such as so-called “smart” phones, so-called “smart” pads, televisions, cameras, display devices, digital media players, video gaming consoles, video streaming device, or the like. In some cases, source device 12 and destination device 14 may be equipped for wireless communication.

Destination device 14 may receive the encoded video data to be decoded via a link 16. Link 16 may comprise any type of medium or device capable of moving the encoded video data from source device 12 to destination device 14. In one example, link 16 may comprise a communication medium to enable source device 12 to transmit encoded video data directly to destination device 14 in real-time. The encoded video data may be modulated according to a communication standard, such as a wireless communication protocol, and transmitted to destination device 14. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 12 to destination device 14.

Alternatively, encoded data may be output from output interface 22 to a storage device 31. Similarly, encoded data may be accessed from storage device 31 by input interface. Storage device 31 may include any of a variety of distributed or locally accessed data storage media such as a hard drive, Blu-ray discs, DVDs, CD-ROMs, flash memory, volatile or non-volatile memory, or any other suitable digital storage media for storing encoded video data. In a further example, storage device 31 may correspond to a file server or another intermediate storage device that may hold the encoded video generated by source device 12. Destination device 14 may access stored video data from storage device 31 via streaming or download. The file server may be any type of server capable of storing encoded video data and transmitting that encoded video data to the destination device 14. Example file servers include a web server (e.g., for a website), an FTP server, network attached storage (NAS) devices, or a local disk drive. Destination device 14 may access the encoded video data through any standard data connection, including an Internet connection. This may include a wireless channel (e.g., a Wi-Fi connection), a wired connection (e.g., DSL, cable modem, etc.), or a combination of both that is suitable for accessing encoded video data stored on a file server. The transmission of encoded video data from storage device 31 may be a streaming transmission, a download transmission, or a combination of both.

The techniques of this disclosure are not necessarily limited to wireless applications or settings. The techniques may be applied to video coding in support of any of a variety of multimedia applications, such as over-the-air television broadcasts, cable television transmissions, satellite television transmissions, streaming video transmissions, e.g., via the Internet, encoding of digital video for storage on a data storage medium, decoding of digital video stored on a data storage medium, or other applications. In some examples, system 10 may be configured to support one-way or two-way video transmission to support applications such as video streaming, video playback, video broadcasting, and/or video telephony.

In the example of FIG. 1, source device 12 includes a video source 18, video encoder 20 and an output interface 22. In some cases, output interface 22 may include a modulator/demodulator (modem) and/or a transmitter. In source device 12, video source 18 may include a source such as a video capture device, e.g., a video camera, a video archive containing previously captured video, a video feed interface to receive video from a video content provider, and/or a computer graphics system for generating computer graphics data as the source video, or a combination of such sources. As one example, if video source 18 is a video camera, source device 12 and destination device 14 may form so-called camera phones or video phones. However, the techniques described in this disclosure may be applicable to video coding in general, and may be applied to wireless and/or wired applications.

The captured, pre-captured, or computer-generated video may be encoded by video encoder 20. The encoded video data may be transmitted directly to destination device 14 via output interface 22 of source device 12. The encoded video data may also (or alternatively) be stored onto storage device 31 for later access by destination device 14 or other devices, for decoding and/or playback.

Destination device 14 includes an input interface 28, a video decoder 30, and a display device 32. In some cases, input interface 28 may include a receiver and/or a modem. Input interface 28 of destination device 14 receives the encoded video data over link 16. The encoded video data communicated over link 16, or provided on storage device 31, may include a variety of syntax elements generated by video encoder 20 for use by a video decoder, such as video decoder 30, in decoding the video data. Such syntax elements may be included with the encoded video data transmitted on a communication medium, stored on a storage medium, or stored a file server.

Display device 32 may be integrated with, or external to, destination device 14. In some examples, destination device 14 may include an integrated display device and also be configured to interface with an external display device. In other examples, destination device 14 may be a display device. In general, display device 32 displays the decoded video data to a user, and may comprise any of a variety of display devices such as a liquid crystal display (LCD), a plasma display, an organic light emitting diode (OLED) display, or another type of display device.

Video encoder 20 and video decoder 30 may operate according to a video compression standard, such as the High Efficiency Video Coding (HEVC) standard presently under development, and may conform to the HEVC Test Model (HM). Alternatively, video encoder 20 and video decoder 30 may operate according to other proprietary or industry standards, such as the ITU-T H.264 standard, alternatively referred to as MPEG-4, Part 10, Advanced Video Coding (AVC), or extensions of such standards. The techniques of this disclosure, however, are not limited to any particular coding standard. Other examples of video compression standards include MPEG-2 and ITU-T H.263.

Although not shown in FIG. 1, in some aspects, video encoder 20 and video decoder 30 may each be integrated with an audio encoder and decoder, and may include appropriate MUX-DEMUX units, or other hardware and software, to handle encoding of both audio and video in a common data stream or separate data streams. If applicable, in some examples, MUX-DEMUX units may conform to the ITU H.223 multiplexer protocol, or other protocols such as the user datagram protocol (UDP).

Video encoder 20 and video decoder 30 each may be implemented as any of a variety of suitable encoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of video encoder 20 and video decoder 30 may be included in one or more encoders or decoders, either of which may be integrated as part of a combined encoder/decoder (CODEC) in a respective device.

The HEVC standardization efforts were based on an evolving model of a video coding device referred to as the HEVC Test Model (HM). The HM presumes several additional capabilities of video coding devices relative to existing devices according to, e.g., ITU-T H.264/AVC. For example, whereas H.264 provides nine intra-prediction encoding modes, the HM may provide as many as thirty-three intra-prediction encoding modes.

In general, the working model of the HM describes that a video frame or picture may be divided into a sequence of treeblocks or largest coding units (LCU) (also called coding tree blocks (CTBs)) that include both luma and chroma samples. A treeblock has a similar purpose as a macroblock of the H.264 standard. A slice includes a number of consecutive treeblocks in coding order. A video frame or picture may be partitioned into one or more slices. Each treeblock may be split into coding units (CUs) according to a quadtree. For example, a treeblock, as a root node of the quadtree, may be split into four child nodes, and each child node may in turn be a parent node and be split into another four child nodes. A final, unsplit child node, as a leaf node of the quadtree, comprises a coding node, i.e., a coded video block. Syntax data associated with a coded bitstream may define a maximum number of times a treeblock may be split, and may also define a minimum size of the coding nodes.

A CU may include a luma coding block and two chroma coding blocks. The CU may have associated prediction units (PUs) and transform units (TUs). Each of the PUs may include one luma prediction block and two chroma prediction blocks, and each of the TUs may include one luma transform block and two chroma transform blocks. Each of the coding blocks may be partitioned into one or more prediction blocks that comprise blocks to samples to which the same prediction applies. Each of the coding blocks may also be partitioned in one or more transform blocks that comprise blocks of sample on which the same transform is applied.

A size of the CU generally corresponds to a size of the coding node and is typically square in shape. The size of the CU may range from 8×8 pixels up to the size of the treeblock with a maximum of 64×64 pixels or greater. Each CU may define one or more PUs and one or more TUs. Syntax data included in a CU may describe, for example, partitioning of the coding block into one or more prediction blocks. Partitioning modes may differ between whether the CU is skip or direct mode encoded, intra-prediction mode encoded, or inter-prediction mode encoded. Prediction blocks may be partitioned to be square or non-square in shape. Syntax data included in a CU may also describe, for example, partitioning of the coding block into one or more transform blocks according to a quadtree. Transform blocks may be partitioned to be square or non-square in shape.

The HEVC standard allows for transformations according to TUs, which may be different for different CUs. The TUs are typically sized based on the size of PUs within a given CU defined for a partitioned LCU, although this may not always be the case. The TUs are typically the same size or smaller than the PUs. In some examples, residual samples corresponding to a CU may be subdivided into smaller units using a quadtree structure known as “residual quad tree” (RQT). The leaf nodes of the RQT may represent the TUs. Pixel difference values associated with the TUs may be transformed to produce transform coefficients, which may be quantized.

In general, a PU includes data related to the prediction process. For example, when the PU is intra-mode encoded, the PU may include data describing an intra-prediction mode for the PU. As another example, when the PU is inter-mode encoded, the PU may include data defining a motion vector for the PU. The data defining the motion vector for a PU may describe, for example, a horizontal component of the motion vector, a vertical component of the motion vector, a resolution for the motion vector (e.g., one-quarter pixel precision or one-eighth pixel precision), a reference picture to which the motion vector points, and/or a reference picture list (e.g., List 0, List 1, or List C) for the motion vector.

In general, a TU is used for the transform and quantization processes. A given CU having one or more PUs may also include one or more TUs. Following prediction, video encoder 20 may calculate residual values from the video block identified by the coding node in accordance with the PU. The coding node is then updated to reference the residual values rather than the original video block. The residual values comprise pixel difference values that may be transformed into transform coefficients, quantized, and scanned using the transforms and other transform information specified in the TUs to produce serialized transform coefficients for entropy coding. The coding node may once again be updated to refer to these serialized transform coefficients. This disclosure typically uses the term “video block” to refer to a coding node of a CU. In some specific cases, this disclosure may also use the term “video block” to refer to a treeblock, i.e., LCU, or a CU, which includes a coding node and PUs and TUs.

A video sequence typically includes a series of video frames or pictures. A group of pictures (GOP) generally comprises a series of one or more of the video pictures. A GOP may include syntax data in a header of the GOP, a header of one or more of the pictures, or elsewhere, that describes a number of pictures included in the GOP. Each slice of a picture may include slice syntax data that describes an encoding mode for the respective slice. Video encoder 20 typically operates on video blocks within individual video slices in order to encode the video data. A video block may correspond to a coding node within a CU. The video blocks may have fixed or varying sizes, and may differ in size according to a specified coding standard.

As an example, the HM supports prediction in various PU sizes. Assuming that the size of a particular CU is 2N×2N, the HM supports intra-prediction in PU sizes of 2N×2N or N×N, and inter-prediction in symmetric PU sizes of 2N×2N, 2N×N, N×2N, or N×N. The HM also supports asymmetric partitioning for inter-prediction in PU sizes of 2N×nU, 2N×nD, nL×2N, and nR×2N. In asymmetric partitioning, one direction of a CU is not partitioned, while the other direction is partitioned into 25% and 75%. The portion of the CU corresponding to the 25% partition is indicated by an “n” followed by an indication of “Up”, “Down,” “Left,” or “Right.” Thus, for example, “2N×nU” refers to a 2N×2N CU that is partitioned horizontally with a 2N×0.5N PU on top and a 2N×1.5N PU on bottom.

In this disclosure, “N×N” and “N by N” may be used interchangeably to refer to the pixel dimensions of a video block in terms of vertical and horizontal dimensions, e.g., 16×16 pixels or 16 by 16 pixels. In general, a 16×16 block will have 16 pixels in a vertical direction (y=16) and 16 pixels in a horizontal direction (x=16). Likewise, an N×N block generally has N pixels in a vertical direction and N pixels in a horizontal direction, where N represents a nonnegative integer value. The pixels in a block may be arranged in rows and columns. Moreover, blocks need not necessarily have the same number of pixels in the horizontal direction as in the vertical direction. For example, blocks may comprise N×M pixels, where M is not necessarily equal to N.

Following intra-predictive or inter-predictive coding using the PUs of a CU, video encoder 20 may calculate residual data to which the transforms specified by TUs of the CU are applied. The residual data may correspond to pixel differences between pixels of the unencoded picture and prediction values corresponding to the CUs. Video encoder 20 may form the residual data for the CU, and then transform the residual data to produce transform coefficients.

Following any transforms to produce transform coefficients, video encoder 20 may perform quantization of the transform coefficients. Quantization generally refers to a process in which transform coefficients are quantized to possibly reduce the amount of data used to represent the coefficients, providing further compression. The quantization process may reduce the bit depth associated with some or all of the coefficients. For example, an n-bit value may be rounded down to an m-bit value during quantization, where n is greater than m.

In some examples, video encoder 20 may utilize a predefined scan order to scan the quantized transform coefficients to produce a serialized vector that can be entropy encoded. In other examples, video encoder 20 may perform an adaptive scan. After scanning the quantized transform coefficients to form a one-dimensional vector, video encoder 20 may entropy encode the one-dimensional vector, e.g., according to context adaptive binary arithmetic coding (CABAC). Video encoder 20 may also entropy encode syntax elements associated with the encoded video data for use by video decoder 30 in decoding the video data.

To perform CABAC, video encoder 20 may assign a context within a context model to a symbol to be transmitted. The context may relate to, for example, whether neighboring values of the symbol are non-zero or not. As described above, video encoder 20 may implement techniques of this disclosure to support multiple parallel parameter set extensions, where the multiple parameter set extensions are defined by multiple HEVC extensions. For example, with respect to a single parameter set (e.g., an SPS or PPS), video encoder 20 may process parameter set extensions defined by the range extension as parallel extensions to parameter set extensions defined by MV-HEVC and/or SHVC. For ease of discussion purposes only, the techniques are described in the following paragraphs with respect to video encoder 20 supporting parallel parameter set extensions defined by the range extension and MV-HEVC. However, it will be appreciated that, in accordance with this disclosure, video encoder 20 may also support parallel parameter set extensions defined by the range extension and SHVC, or any other extension/amendment to HEVC. By implementing the techniques described herein, video encoder 20 may improve signaling efficiency by decoupling MV-HEVC-defined syntax structures of the parameter set from various range extension-defined syntax structures of the same parameter set. According to the techniques of this disclosure, video encoder 20 may be configured to support parameter set extensions defined by each of the range extension and MV-HEVC, even if each of the range extension and MV-HEVC is built directly on top of HEVC.

Video encoder 20 may implement the techniques described herein by using one or more extension flags. According to various aspects of this disclosure, video encoder 20 may use an HEVC-defined extension flag to support multiple parallel extensions according to aspects of this disclosure. An example of an existing extension flags defined in HEVC that video encoder 20 may use according to the techniques described herein include an sps_extension_flag and/or a pps_extension_flag.

By applying the techniques of this disclosure, video encoder 20 may use the sps_extension_flag and/or the pps_extension_flag to indicate whether the respective parameter set includes any parameter set extension syntax structures, regardless of which HEVC extension defines any such parameter set extension syntax structures. For example, according to the techniques described herein, video encoder 20 may set the sps_extension_flag to a value of 1 to indicate that the corresponding SPS includes one or more parameter set extension syntax structures (e.g., that the one or more extension structures “are present within the corresponding SPS”). Conversely, video encoder 20 may set the sps_extension_flag to a value of 0 to indicate that the corresponding SPS does not include any parameter set extension syntax structures.

As described above, according to various aspects of this disclosure, video encoder 20 may be configured to process parameter set extensions defined by the range extension and parameter set extensions defined by MV-HEVC as parallel parameter set extensions (e.g., as parameter set extensions that may be implemented independently of one another). To support multiple parallel extensions for a given parameter set in this manner, video encoder 20 may use an extension flag to indicate only the presence or absence of any parameter set extension. If the extension flag is set to a “true” value (e.g., a value of one), video encoder 20 may, in turn, use a dedicated flag to indicate the presence or absence of particular parameter set extension syntax structures defined by each supported HEVC extension (e.g., the range extension and MV-HEVC). Conversely, if the extension flag is set to a “false” value (e.g., a value of zero), then video encoder 20 may not encode any dedicated flags to indicate the presence or absence of particular parameter set extensions defined by each of the supported HEVC extensions (e.g., the range extension and MV-HEVC).

For instance, video encoder 20 may use the sps_extension_flag to indicate whether the corresponding SPS includes any parameter set extension syntax structures, regardless of which HEVC extension may define such parameter set extension syntax structures. If video encoder 20 sets the sps_extension_flag to a value of 1 (to indicate that the parameter set includes at least one parameter set extension), then video encoder 20 may use a dedicated flag to indicate whether particular parameter set extensions are present, based on the particular HEVC extension that defines the parameter set extensions. For instance, video encoder 20 may use a range_ext_flag syntax element to indicate whether the corresponding SPS includes any SPS extensions defined by the range extension to HEVC. Similarly, video encoder 20 may use a multi_layer_ext_flag syntax element to indicate whether the corresponding SPS includes any SPS extensions defined by the range extension to MV-HEVC. In some examples, video encoder 20 may use a sps_mv_extension2_flag syntax element to indicate whether the corresponding SPS includes any SPS extensions defined by SHVC.

Additionally, in accordance with various aspects of this disclosure, video encoder 20 may support parallel extensions for parameter sets in a variety of manners. In some examples, video encoder 20 may define a fixed number of parallel parameter set extensions that can be supported for a given parameter set. In one such example, video encoder 20 may fix the number of parallel parameter set extensions per parameter set at two. For instance, the two parallel extensions supported by video encoder 20 for a given parameter set may be a parameter set extension for the range extension and a parameter set extension for MV-HEVC. In some examples, video encoder 20 may signal, as part of the encoded video bitstream, the number of parallel parameter set extensions supported with respect to a given parameter set.

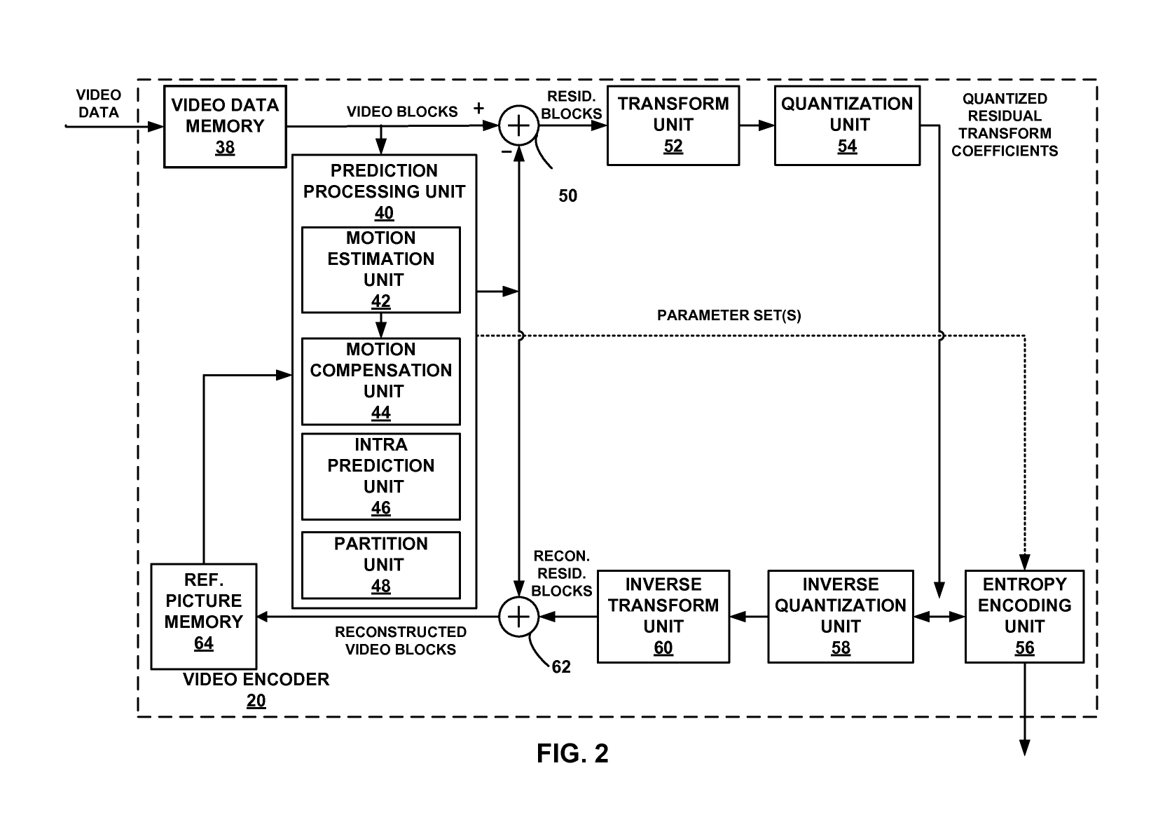

FIG. 2 is a block diagram illustrating an example of video encoder 20 that may implement techniques for encoding video data, in accordance with one or more aspects of this disclosure. For instance, video encoder 20 and components thereof, as illustrated in FIG. 2, may be configured or otherwise operable to implement or otherwise utilize one or more of the parallel extension-based techniques of this disclosure. Video encoder 20 may perform intra- and inter-coding of video blocks within video slices. Intra-coding relies on spatial prediction to reduce or remove spatial redundancy in video within a given video frame or picture. Inter-coding relies on temporal prediction to reduce or remove temporal redundancy in video within adjacent frames or pictures of a video sequence. Intra-mode (I mode) may refer to any of several spatial based coding modes. Inter-modes, such as uni-directional prediction (P mode) or bi-prediction (B mode), may refer to any of several temporal-based coding modes.

As shown in FIG. 2, video encoder 20 receives a current video block within a video frame to be encoded. In the example of FIG. 2, video encoder 20 includes video data memory 38, prediction processing unit 40, reference picture memory 64, summer 50, transform processing unit 52, quantization unit 54, and entropy encoding unit 56. Prediction processing unit 41, in turn, includes motion compensation unit 44, motion estimation unit 42, and intra-prediction unit 46, and partition unit 48. For video block reconstruction, video encoder 20 also includes inverse quantization unit 58, inverse transform unit 60, and summer 62. A deblocking filter (not shown in FIG. 2) may also be included to filter block boundaries to remove blockiness artifacts from reconstructed video. If desired, the deblocking filter would typically filter the output of summer 62. Additional filters (in loop or post loop) may also be used in addition to the deblocking filter. Such filters are not shown for brevity, but if desired, may filter the output of summer 62 (as an in-loop filter).

Video data memory 38 may store video data to be encoded by the components of video encoder 20. The video data stored in video data memory 38 may be obtained, for example, from video source 18. Video data memory 38 may be a reference picture memory that stores reference video data for use in encoding video data by video encoder 20, e.g., in intra- or inter-coding modes. Video data memory 38 may be formed by any of a variety of memory devices, such as dynamic random access memory (DRAM), including synchronous DRAM (SDRAM), magnetoresistive RAM (MRAM), resistive RAM (RRAM), or other types of memory devices. Video data memory 38 may be provided by the same memory device or separate memory devices. In various examples, video data memory 38 may be on-chip with other components of video encoder 20, or off-chip relative to those components.

During the encoding process, video encoder 20 receives a video frame or slice to be coded. The frame or slice may be divided into multiple video blocks by prediction processing unit 41. Motion estimation unit 42 and motion compensation unit 44 perform inter-predictive coding of the received video block relative to one or more blocks in one or more reference frames to provide temporal prediction. Intra-prediction unit 46 may alternatively perform intra-predictive coding of the received video block relative to one or more neighboring blocks in the same frame or slice as the block to be coded to provide spatial prediction. Video encoder 20 may perform multiple coding passes, e.g., to select an appropriate coding mode for each block of video data.

Moreover, partition unit 48 may partition blocks of video data into sub-blocks, based on evaluation of previous partitioning schemes in previous coding passes. For example, partition unit 48 may initially partition a frame or slice into LCUs, and partition each of the LCUs into sub-CUs based on rate-distortion analysis (e.g., rate-distortion optimization). Prediction processing unit 40 may further produce a quadtree data structure indicative of partitioning of an LCU into sub-CUs. Leaf-node CUs of the quadtree may include one or more PUs and one or more TUs.

Prediction processing unit 40 may select one of the coding modes, intra or inter, e.g., based on error results, and provides the resulting intra- or inter-coded block to summer 50 to generate residual block data and to summer 62 to reconstruct the encoded block for use as a reference frame. Prediction processing unit 40 also provides syntax elements, such as motion vectors, intra-mode indicators, partition information, and other such syntax information, to entropy encoding unit 56. Prediction processing unit 40 may select one or more inter-modes using rate-distortion analysis.

Motion estimation unit 42 and motion compensation unit 44 may be highly integrated, but are illustrated separately for conceptual purposes. Motion estimation, performed by motion estimation unit 42, is the process of generating motion vectors, which estimate motion for video blocks. A motion vector, for example, may indicate the displacement of a PU of a video block within a current video frame or picture relative to a predictive block within a reference frame (or other coded unit) relative to the current block being coded within the current frame (or other coded unit). A predictive block is a block that is found to closely match the block to be coded, in terms of pixel difference, which may be determined by sum of absolute difference (SAD), sum of square difference (SSD), or other difference metrics. In some examples, video encoder 20 may calculate values for sub-integer pixel positions of reference pictures stored in reference picture memory 64. For example, video encoder 20 may interpolate values of one-quarter pixel positions, one-eighth pixel positions, or other fractional pixel positions of the reference picture. Therefore, motion estimation unit 42 may perform a motion search relative to the full pixel positions and fractional pixel positions and output a motion vector with fractional pixel precision.

Motion estimation unit 42 calculates a motion vector for a PU of a video block in an inter-coded slice by comparing the position of the PU to the position of a predictive block of a reference picture. The reference picture may be selected from a first reference picture list (List 0) or a second reference picture list (List 1), each of which identify one or more reference pictures stored in reference picture memory 64. Motion estimation unit 42 sends the calculated motion vector to entropy encoding unit 56 and motion compensation unit 44.

Motion compensation, performed by motion compensation unit 44, may involve fetching or generating the predictive block based on the motion vector determined by motion estimation unit 42. Again, motion estimation unit 42 and motion compensation unit 44 may be functionally integrated, in some examples. Upon receiving the motion vector for the PU of the current video block, motion compensation unit 44 may locate the predictive block to which the motion vector points in one of the reference picture lists. Summer 50 forms a residual video block by subtracting pixel values of the predictive block from the pixel values of the current video block being coded, forming pixel difference values, as discussed below. In general, motion estimation unit 42 performs motion estimation relative to luma coding blocks, and motion compensation unit 44 uses motion vectors calculated based on the luma coding blocks for both chroma coding blocks and luma coding blocks. Prediction processing unit 40 may also generate syntax elements associated with the video blocks and the video slice for use by video decoder 30 in decoding the video blocks of the video slice.

Intra-prediction unit 46 may intra-predict a current block, as an alternative to the inter-prediction performed by motion estimation unit 42 and motion compensation unit 44, as described above. In particular, intra-prediction unit 46 may determine an intra-prediction mode to use to encode a current block. In some examples, intra-prediction unit 46 may encode a current block using various intra-prediction modes, e.g., during separate encoding passes, and intra-prediction unit 46 (or prediction processing unit 40, in some examples) may select an appropriate intra-prediction mode to use from the tested modes.

For example, intra-prediction unit 46 may calculate rate-distortion values using a rate-distortion analysis for the various tested intra-prediction modes, and select the intra-prediction mode having the best rate-distortion characteristics among the tested modes. Rate-distortion analysis generally determines an amount of distortion (or error) between an encoded block and an original, unencoded block that was encoded to produce the encoded block, as well as a bitrate (that is, a number of bits) used to produce the encoded block. Intra-prediction unit 46 may calculate ratios from the distortions and rates for the various encoded blocks to determine which intra-prediction mode exhibits the best rate-distortion value for the block.

After selecting an intra-prediction mode for a block, intra-prediction unit 46 may provide information indicative of the selected intra-prediction mode for the block to entropy encoding unit 56. Entropy encoding unit 56 may encode the information indicating the selected intra-prediction mode. Video encoder 20 may include in the transmitted bitstream configuration data, which may include a plurality of intra-prediction mode index tables and a plurality of modified intra-prediction mode index tables (also referred to as codeword mapping tables), definitions of encoding contexts for various blocks, and indications of a most probable intra-prediction mode, an intra-prediction mode index table, and a modified intra-prediction mode index table to use for each of the contexts.

Video encoder 20 forms a residual video block by subtracting the prediction data from mode select unit 40 from the original video block being coded. Summer 50 represents the component or components that perform this subtraction operation. Transform processing unit 52 applies a transform, such as a discrete cosine transform (DCT) or a conceptually similar transform, to the residual block, producing a video block comprising residual transform coefficient values. Transform processing unit 52 may perform other transforms which are conceptually similar to DCT. Wavelet transforms, integer transforms, sub-band transforms or other types of transforms could also be used. In any case, transform processing unit 52 applies the transform to the residual block, producing a block of residual transform coefficients. The transform may convert the residual information from a pixel value domain to a transform domain, such as a frequency domain. Transform processing unit 52 may send the resulting transform coefficients to quantization unit 54. Quantization unit 54 quantizes the transform coefficients to further reduce bit rate. The quantization process may reduce the bit depth associated with some or all of the coefficients. The degree of quantization may be modified by adjusting a quantization parameter. In some examples, quantization unit 54 may then perform a scan of the matrix including the quantized transform coefficients. Alternatively, entropy encoding unit 56 may perform the scan.

Following quantization, entropy encoding unit 56 entropy codes the quantized transform coefficients. For example, entropy encoding unit 56 may perform context adaptive variable length coding (CAVLC), context adaptive binary arithmetic coding (CABAC), syntax-based context-adaptive binary arithmetic coding (SBAC), probability interval partitioning entropy (PIPE) coding or another entropy coding technique. In the case of context-based entropy coding, context may be based on neighboring blocks. Following the entropy coding by entropy encoding unit 56, the encoded bitstream may be transmitted to another device (e.g., video decoder 30) or archived for later transmission or retrieval.

Inverse quantization unit 58 and inverse transform unit 60 apply inverse quantization and inverse transformation, respectively, to reconstruct the residual block in the pixel domain, e.g., for later use as a reference block. Motion compensation unit 44 may calculate a reference block by adding the residual block to a predictive block of one of the frames of reference picture memory 64. Motion compensation unit 44 may also apply one or more interpolation filters to the reconstructed residual block to calculate sub-integer pixel values for use in motion estimation. Summer 62 adds the reconstructed residual block to the motion compensated prediction block produced by motion compensation unit 44 to produce a reconstructed video block for storage in reference picture memory 64. The reconstructed video block may be used by motion estimation unit 42 and motion compensation unit 44 as a reference block to inter-code a block in a subsequent video frame.

As described above with respect to FIG. 1, video encoder 20 (and/or various components thereof, such as entropy encoding unit 56) may implement techniques of this disclosure to treat parameter set extensions for one or both of MV-HEVC and SHVC as parallel parameter set extensions to a parameter set extension to the range extension. Extension-defined coding techniques that are supported in aspects of this disclosure, as well as further details of various techniques of this disclosure, are described below.

The range extension of HEVC may be implemented as the first amendment (or “amendment 1”) of HEVC version 1. Additionally, MV-HEVC may be implemented as the second amendment (or “amendment 2”) of HEVC version 1, and SHVC may be implemented as the third amendment (or “amendment 3”) of HEVC version 1. Thus, the MV-HEVC text may be built eventually on top of the range extension specification. With respect to MV-HEVC, it is possible (even highly possible or probable) that aspects of MV-HEVC will not necessarily require all the features in the range extension to be utilized. As such, various syntax elements in the range extension (e.g., in a parameter set extension related to the range extension) may be unnecessary for MV-HEVC. SHVC is an extension of MV-HEVC from a syntax structure point of view, so for purposes of this disclosure, it can be assumed that the syntax elements in MV-HEVC may be still necessary for SHVC.

To convey additional information (e.g., by video encoder 20) provided by various HEVC extensions, an SPS extension may be included in an extension specification. With respect to SPS extensions for the range extension, the syntax table with respect to SPS is illustrated in Table 1A below:

TABLE 1A
SPS Syntax Table for Range Extension

| seq_parameter_set_rbsp( ) { | Descriptor |
|---|---|
| sps_video_parameter_set_id | u(4) |
| sps_max_sub_layers_minus1 | u(3) |
| sps_temporal_id_nesting_flag | u(1) |
| profile_tier_level( sps_max_sub_layers_minus1 ) | |
| sps_seq_parameter_set_id | ue(v) |
| chroma_format_idc | ue(v) |
| if( chroma_format_idc = = 3 ) | |
| separate_colour_plane_flag | u(1) |
| pic_width_in_luma_samples | ue(v) |
| pic_height_in_luma_samples | ue(v) |
| conformance_window_flag | u(1) |
| if( conformance_window_flag ) { | |
| conf_win_left_offset | ue(v) |
| conf_win_right_offset | ue(v) |
| conf_win_top_offset | ue(v) |
| conf_win_bottom_offset | ue(v) |
| } | |
| bit_depth_luma_minus8 | ue(v) |
| bit_depth_chroma_minus8 | ue(v) |
| log2_max_pic_order_cnt_lsb_minus4 | ue(v) |
| sps_sub_layer_ordering_info_present_flag | u(1) |
| for( i = ( sps_sub_layer_ordering_info_present_flag ? 0 : | |
| sps_max_sub_layers_minus1 ); | |
| i <= sps_max_sub_layers_minus1; i++ ) { | |
| sps_max_dec_pic_buffering_minus1[ i ] | ue(v) |
| sps_max_num_reorder_pics[ i ] | ue(v) |
| sps_max_latency_increase_plus1[ i ] | ue(v) |
| } | |
| log2_min_luma_coding_block_size_minus3 | ue(v) |
| log2_diff_max_min_luma_coding_block_size | ue(v) |
| log2_min_transform_block_size_minus2 | ue(v) |
| log2_diff_max_min_transform_block_size | ue(v) |
| max_transform_hierarchy_depth_inter | ue(v) |
| max_transform_hierarchy_depth_intra | ue(v) |
| scaling_list_enabled_flag | u(1) |
| if( scaling_list_enabled_flag ) { | |
| sps_scaling_list_data_present_flag | u(1) |
| if( sps_scaling_list_data_present_flag ) | |
| scaling_list_data( ) | |
| } | |
| amp_enabled_flag | u(1) |
| sample_adaptive_offset_enabled_flag | u(1) |
| pcm_enabled_flag | u(1) |
| if( pcm_enabled_flag ) { | |
| pcm_sample_bit_depth_luma_minus1 | u(4) |
| pcm_sample_bit_depth_chroma_minus1 | u(4) |
| log2_min_pcm_luma_coding_block_size_minus3 | ue(v) |
| log2_diff_max_min_pcm_luma_coding_block_size | ue(v) |
| pcm_loop_filter_disabled_flag | u(1) |
| } | |
| num_short_term_ref_pic_sets | ue(v) |
| for( i = 0; i < num_short_term_ref_pic_sets; i++) | |
| short_term_ref_pic_set( i ) | |
| long_term_ref_pics_present_flag | u(1) |
| if( long_term_ref_pics_present_flag ) { | |
| num_long_term_ref_pics_sps | ue(v) |
| for( i = 0; i < num_long_term_ref_pics_sps; i++ ) { | |
| lt_ref_pic_poc_ lsb_sps[ i ] | u(v) |
| used_by_curr_pic_lt_sps_flag[ i ] | u(1) |
| } | |
| } | |
| sps_temporal_mvp_enabled_flag | u(1) |
| strong_intra_smoothing_enabled_flag | u(1) |
| vui_parameters_present_flag | u(1) |
| if( vui_parameters_present_flag ) | |
| vui_parameters( ) | |
| sps_extension1_flag | u(1) |
| if( sps_extension1_flag ) { | |
| transform skip rotation enabled flag | u(1) |
| transform skip context enabled flag | u(1) |
| intra block copy enabled flag | u(1) |
| residual dpcm intra enabled flag | u(1) |
| residual dpcm inter enabled flag | u(1) |
| extended precision processing flag | u(1) |
| intra smoothing disabled flag | u(1) |
| sps extension2 flag | u(1) |
| } | |
| if( sps_extension2_flag ) | |
| while( more_rbsp_data( ) ) | |
| sps_extension_data_flag | u(1) |
| rbsp_trailing_bits( ) | |
| } | |

In Table 1A above, additional syntax elements used in the SPS to support coding techniques of the range extension are distinguished by underlining Editorially, an SPS range extension parameter set is shown in Table 1B below, with underlining to distinguish changes introduced by the range extension:

TABLE 1B
(Editorial) SPS Syntax Table for Range Extension

| sps_range_extension ( ) { | |
|---|---|
| transform_skip_rotation_enabled_flag | u(1) |
| transform_skip_context_enabled_flag | u(1) |
| intra_block_copy_enabled_flag | u(1) |
| residual_dpcm_intra_enabled_flag | u(1) |
| residual_dpcm_inter_enabled_flag | u(1) |
| extended_precision_processing_flag | u(1) |
| intra_smoothing_disabled_flag | u(1) |
| sps_extension2_flag | u(1) |
| } | |

MV-HEVC may also use additional syntax elements in an extension to the SPS, which is illustrated in Tables 2A & 2B below:

TABLE 2A
Syntax Table Showing SPS Extension Addition In MV-HEVC

| seq_parameter_set_rbsp( ) { | Descriptor |
|---|---|
| sps_video_parameter_set_id | u(4) |
| if( nuh_layer_id = = 0 ) { | |
| sps_max_sub_layers_minus1 | u(3) |
| sps_temporal_id_nesting_flag | u(1) |
| profile_tier_level( 1, sps_max_sub_layers_minus1 ) | |
| } | |
| sps_seq_parameter_set_id | ue(v) |
| if( nuh_layer_id > 0 ) | |
| update_rep_format_flag | u(1) |
| if( update_rep_format_flag ) { | |
| chroma_format_idc | ue(v) |
| if( chroma_format_idc = = 3 ) | |
| separate_colour_plane_flag | u(1) |
| pic_width_in_luma_samples | ue(v) |
| pic_height_in_luma_samples | ue(v) |
| } | |
| conformance_window_flag | u(1) |
| if( conformance_window_flag ) { | |
| conf_win_left_offset | ue(v) |
| conf_win_right_offset | ue(v) |
| conf_win_top_offset | ue(v) |
| conf_win_bottom_offset | ue(v) |
| } | |
| if( update_rep_format_flag ) { | |
| bit_depth_luma_minus8 | ue(v) |
| bit_depth_chroma_minus8 | ue(v) |
| } | |
| log2_max_pic_order_cnt_lsb_minus4 | ue(v) |
| sps_sub_layer_ordering_info_present_flag | u(1) |
| for( i = ( sps_sub_layer_ordering_info_present_flag ? 0 : | |
| sps_max_sub_layers_minus1 ); | |
| i <= sps_max_sub_layers_minus1; i++ ) { | |
| sps_max_dec_pic_buffering_minus1[ i ] | ue(v) |
| sps_max_num_reorder_pics[ i ] | ue(v) |
| sps_max_latency_increase_plus1[ i ] | ue(v) |
| } | |
| log2_min_luma_coding_block_size_minus3 | ue(v) |
| log2_diff_max_min_luma_coding_block_size | ue(v) |
| log2_min_transform_block_size_minus2 | ue(v) |
| log2_diff_max_min_transform_block_size | ue(v) |
| max_transform_hierarchy_depth_inter | ue(v) |
| max_transform_hierarchy_depth_intra | ue(v) |
| scaling_list_enabled_flag | u(1) |
| if( scaling_list_enabled_flag ) { | |
| if( nuh_layer_id > 0 ) | |
| sps_infer_scaling_list_flag | u(1) |
| if( sps_infer_scaling_list_flag ) | |
| sps_scaling_list_ref_layer_id | u(6) |
| else { | |
| sps_scaling_list_data_present_flag | u(1) |
| if( sps_scaling_list_data_present_flag ) | |
| scaling_list_data( ) | |
| } | |
| } | |
| amp_enabled_flag | u(1) |
| sample_adaptive_offset_enabled_flag | u(1) |
| pcm_enabled_flag | u(1) |
| if( pcm_enabled_flag ) { | |
| pcm_sample_bit_depth_luma_minus1 | u(4) |
| pcm_sample_bit_depth_chroma_minus1 | u(4) |
| log2_min_pcm_luma_coding_block_size_minus3 | ue(v) |
| log2_diff_max_min_pcm_luma_coding_block_size | ue(v) |
| pcm_loop_filter_disabled_flag | u(1) |
| } | |
| num_short_term_ref_pic_sets | ue(v) |
| for( i = 0; i < num_short_term_ref_pic_sets; i++) | |
| short_term_ref_pic_set( i ) | |
| long_term_ref_pics_present_flag | u(1) |
| if( long_term_ref_pics_present_flag ) { | |
| num_long_term_ref_pics_sps | ue(v) |
| for( i = 0; i < num_long_term_ref_pics_sps; i++ ) { | |
| lt_ref_pic_po_ lsb_sps[ i ] | u(v) |
| used_by_curr_pic_lt_sps_flag[ i ] | u(1) |
| } | |
| } | |
| sps_temporal_mvp_enabled_flag | u(1) |
| strong_intra_smoothing_enabled_flag | u(1) |
| vui_parameters_present_flag | u(1) |
| if( vui_parameters_present_flag ) | |
| vui_parameters( ) | |
| sps_extension_flag | u(1) |
| if( sps_extension_flag ) { | |
| sps_extension( ) | |
| sps_extension2_flag | u(1) |
| if( sps_extension2_flag ) | |
| while( more_rbsp_data( ) ) | |
| sps_extension_data_flag | u(1) |
| } | |
| rbsp_trailing_bits( ) | |
| } | |

TABLE 2B
Syntax Table For MV-HEVC SPS Extension

| sps_extension( ) { | Descriptor |
|---|---|
| inter_view_mv_vert_constraint_flag | u(1) |
| sps_shvc_reserved_zero_idc | ue(v) |
| } | |

Changes introduced by the MV-HEVC SPS extension to existing SPS syntax provided by HEVC are distinguished in Table 2A using italicized text. For ease of discussion purposes only, for the remainder of this disclosure, the SPS extension (sps_extension( ) ) of MV-HEVC is referred to as “sps_mv_extension( ) .”

Both of the range extension and the MV-HEVC extension utilize the same sps_extension_flag to indicate the presence of the SPS extension. Regardless of which SPS extension is to be assigned a higher priority (which, in many scenarios, is the range extension), such that sps_extension2_flag is used to contain the other (e.g., lower-priority) SPS extension, the following potential issue may arise: If MV-HEVC is implemented as an extension of the range extension, the SPS range extension must be present, regardless of whether the MV-HEVC bitstream is built on top of the range extension features. Such a design may introduce potential issues (e.g., inefficiencies), as MV-HEVC may be built on top of HEVC without the range extension. Therefore, the presence of the SPS range extension bits in an MV-HEVC bitstream may be potentially wasteful and/or computationally inefficient with respect to operations (e.g., signaling) performed by video encoder 20.

This disclosure is generally directed to techniques (and, in examples, provides a mechanism) by which video encoder 20 may support multiple parallel extensions in a parameter set or other syntax structures. In various examples, video encoder 20 may support MV-HEVC and the range extension as the parallel extensions. For ease of discussion purposes, as used herein, “the multiple parallel extensions” to which the techniques of this disclosure are generally directed may include MV-HEVC and the range extension. Although the multiple parallel extensions are discussed herein as including MV-HEVC and the range extension, it will be understood that, in accordance with aspects of this disclosure, video encoder may treat SHVC as a parallel extension of MV-HEVC, as well.

According to some implementations of the techniques of the disclosure, video encoder 20 may not use the sps_extension_flag (or pps_extension_flag, or any last bit flag in a parameter set or other syntax structures of a base layer codec) which extension the respective parameter set contains. Instead, according to these implementations, video encoder 20 may use the sps_extension_flag (or pp_extension_flag or other last bit flag as described above) to specify whether the respective parameter set includes one or more extension syntax structures. For instance, video encoder 20 may set the value of such a flag (e.g., sps_extension_flag) equal to 1, to indicate that one or more extension syntax structures are present in the corresponding SPS. For each parallel extension, video encoder 20 may use one flag to indicate the presence of the particular extension. For instance, with respect to a particular SPS, video encoder 20 may use sps_extension_flag_{—}1 to indicate whether any range extension syntax structures are included, and may use sps_extension_flag_{—}2 to indicate whether any MV-HEVC syntax structures are included. In one example, video encoder 20 may set a fixed number of parallel extensions that are supported for a given parameter set. In another example, video encoder 20 may signal the number of parallel extensions to video decoder 30.

Described under the heading “Example Implementation #1” below, is one example by which video encoder 20 may apply various techniques of this disclosure with respect to the extensions of the SPS. Although described with respect to SPS extensions for ease of discussion purposes, it will be appreciated that video encoder 20 may apply the techniques described in Example Implementation #1 to one or more of PPS, video parameter set (VPS), and other syntax structures, as and when applicable, called-for, and/or necessary.

TABLE 3A
Sequence parameter set (SPS) applicable to any extension

| seq_parameter_set_rbsp( ) { | Descriptor |
|---|---|
| sps_video_parameter_set_id | u(4) |
| if( nuh_layer_id = =0 ) { | |
| sps_max_sub_layers_minus1 | u(3) |
| sps_temporal_id_nesting_flag | u(1) |
| profile_tier_level( 1, sps_max_sub_layers_minus1 ) | |
| } | |
| sps_seq_parameter_set_id | ue(v) |
| if( nuh layer id > 0 ) | |
| update_rep_format_flag | u(1) |
| if( update_rep_format_flag ) { | |
| chroma_format_idc | ue(v) |
| if( chroma_format_idc = = 3 ) | |
| separate_colour_plane_flag | u(1) |
| pic_width_in_luma_samples | ue(v) |
| pic_height_in_luma_samples | ue(v) |
| } | |
| conformance_window_flag | u(1) |
| if( conformance_window_flag ) { | |
| conf_win_left_offset | ue(v) |
| conf_win_right_offset | ue(v) |
| conf_win_top_offset | ue(v) |
| conf_win_bottom_offset | ue(v) |
| } | |
| if( update_rep_format_flag ) { | |
| bit_depth_luma_minus8 | ue(v) |
| bit_depth_chroma_minus8 | ue(v) |
| } | |
| log2_max_pic_order_cnt_lsb_minus4 | ue(v) |
| sps_sub_layer_ordering_info_present_flag | u(1) |
| for( i = ( sps_sub_layer_ordering_info_present_flag ? 0 : | |
| sps_max_sub_layers_minus1 ); | |
| i <= sps_max_sub_layers_minus1; i++ ) { | |
| sps_max_dec_pic_buffering_minus1[ i ] | ue(v) |
| sps_max_num_reorder_pics[ i ] | ue(v) |
| sps_max_latency_increase_plus1[ i ] | ue(v) |
| } | |
| log2_min_luma_coding_block_size_minus3 | ue(v) |
| log2_diff_max_min_luma_coding_block_size | ue(v) |
| log2_min_transform_block_size_minus2 | ue(v) |
| log2_diff_max_min_transform_block_size | ue(v) |
| max_transform_hierarchy_depth_inter | ue(v) |
| max_transform_hierarchy_depth_intra | ue(v) |
| scaling_list_enabled_flag | u(1) |
| if( scaling_list_enabled_flag ) { | |
| if( nuh_layer_id > 0 ) | |
| sps_infer_scaling_list_flag | u(1) |
| if( sps_infer_scaling_list_flag ) | |
| sps_scaling_list_ref_layer_id | u(6) |
| else { | |
| sps_scaling_list_data_present_flag | u(1) |
| if( sps_scaling_list_data_present_flag ) | |
| scaling_list_data( ) | |
| } | |
| } | |
| amp_enabled_flag | u(1) |
| sample_adaptive_offset_enabled_flag | u(1) |
| pcm_enabled_flag | u(1) |
| if( pcm_enabled_flag ) { | |
| pcm_sample_bit_depth_luma_minus1 | u(4) |
| pcm_sample_bit_depth_chroma_minus1 | u(4) |
| log2_min_pcm_luma_coding_block_size_minus3 | ue(v) |
| log2_diff max_min_pcm_luma_coding_block_size | ue(v) |
| pcm_loop_filter_disabled_flag | u(1) |
| } | |
| num_short_term_ref_pic_sets | ue(v) |
| for( i = 0; i < num_short_term_ref_pic_sets; i++) | |
| short_term_ref_pic_set( i ) | |
| long_term_ref_pics_present_flag | u(1) |
| if( long_term_ref_pics_present_flag ) { | |
| num_long_term_ref_pics_sps | ue(v) |
| for( i = 0; i < num_long_term_ref_pics_sps; i++ ) { | |
| lt_ref_pic_poc_lsb_sps[ i ] | u(v) |
| used_by_curr_pic_lt_sps_flag[ i ] | u(1) |
| } | |
| } | |
| sps_temporal_mvp_enabled_flag | u(1) |
| strong_intra_smoothing_enabled_flag | u(1) |
| vui_parameters_present_flag | u(1) |
| if( vui_parameters_present_flag ) | |
| vui_parameters( ) | |
| sps_extension_flag | u(1) |
| if( sps_extension_flag ) [symbol] | |
| sps_extension( ) | |
| [symbol] | [symbol] |
| [symbol] | |
| [symbol] | |
| [symbol] | [symbol] |
| } | |
| rbsp_trailing_bits( ) | |
| } | |

Table 3A illustrates an example of syntax associated with an SPS that video encoder 20 may be apply across any extension (e.g., the range extension and/or MV-HEVC), in accordance with an example implementation of the techniques described herein. In Table 3A, changes introduced by this example to existing SPS syntax (applicable to any extension) are distinguished using single-line underlining to denote additions, and strike-through to denote deletions. In Table 3A, in instances where the value of the sps_extension1_flag is equal to 1, video encoder 20 may use the sps_extension1_flag to specify that an extension to the corresponding parameter set is present (e.g., as in sps_extension( ) ). On the other hand, if video encoder 20 sets the value of the sps_extension1_flag equal to 0, the sps_extension1_flag specifies that an extension to the corresponding parameter set is not present (e.g., that no extension to the corresponding parameter set is present).

TABLE 3B
Syntax Table For SPS Extension

| sps_extension( ) { | Descriptor |
|---|---|
| range ext flag | u(1) |
| multi layer ext flag | u(1) |
| if( range_ext_flag ) | |
| sps_range_extension( ) | |
| if( multi layer ext flag ) | |
| sps my extension( ) | |
| sps futher extension flag | u(1) |
| if( sps_further_extension_flag ) | |
| while( more_rbsp_data( ) ) | |
| sps further extension data flag | u(1) |
| } | |

Syntax table 3B above describes syntax associated with the SPS Extension, in accordance with Example Implementation #1 performed by video encoder 20. In Table 3A, changes introduced by this example implementation to existing SPS extension syntax are distinguished by various font formatting changes. For instance, and following the formatting of Table 3A, single-line underlining in Table 3B denotes changes that this example implementation may introduce to SPS syntax, with respect to any extension, such as one or more of the range extension, MV-HEVC, or SHVC. Additionally, in Table 3B, italicization denotes changes that video encoder 20 may introduce to existing SPS syntax, with respect to the range extension, according to this example implementation. Additionally, in Table 3B, double-line underlining denotes changes that video encoder 20 may introduce to SPS syntax with respect to MV-HEVC, according to this example implementation. Changes that video encoder 20 may introduce to existing SPS semantics according to this example implementation are described below.

Video encoder 20 may set the range_ext_flag syntax element equal to 1, to specify that sps_range_extension( ) is present for the corresponding SPS. Conversely, video encoder 20 may set the range_ext_flag syntax element equal to 0, to specify that sps_range_extension( ) is not present for the corresponding SPS.

Video encoder 20 may set the multi_layer_ext_flag syntax element equal to 1, to specify that sps_mv_extension( ) is present for the corresponding SPS. Conversely, video encoder 20 may set the range_ext_flag syntax element equal to 0 to specifies that sps_mv_extension( ) is not present for the corresponding SPS.

Video encoder 20 may set the sps_futher_extension_flag syntax element equal to 0 to specify that no sps_further_extension_data_flag syntax elements are present in the SPS RBSP syntax structure for the corresponding SPS. In cases where one or more sps_further_extension_data_flag syntax elements are present in the SPS RBSP syntax structure for the corresponding SPS, video encoder 20 may set the sps_further_extension_data_flag syntax element to 0 for encoded video bitstreams. Additionally, in cases where one or more sps_further_extension_data_flag syntax elements are present in the SPS RBSP syntax structure for the corresponding SPS, video encoder 20 may infer the value of the sps_further_extension_data_flag syntax element to be equal to 0. The value of 1 for the sps_further_extension_data_flag syntax element is reserved for future use by ITU-T|ISO/IEC. Various video decoding devices, such as video decoder 30, may allow the value of sps_further_extension_data_flag syntax element to be equal to 1 (when the sps_further_extension_data_flag syntax element is present), and may ignore all sps_further_extension_data_flag syntax elements that follow the value 1 for the sps_futher_extension_flag syntax element in a given SPS NAL unit.

Video encoder 20 may set the sps_further_extension_data_flag syntax element to any value. The presence and/or value of the sps_further_extension_data_flag syntax element may not affect or alter decoder conformance to the example implementation described herein. Decoders, such as video decoder 30, conforming to the example implementation described herein, may ignore all sps_further_extension_data_flag syntax elements.

According to one alternative, in accordance with one or more aspects of this disclosure, video encoder 20 may provide no extensibility for the sps_extension( ) as shown in Table 3C below. Changes introduced to existing SPS syntax are distinguished in Table 3C according to the same font formatting described above with respect to Tables 3A & 3B.

TABLE 3C
No Extensibility with respect to sps extension( )

| sps_extension( ) { | Descriptor |
|---|---|
| range ext flag | u(1) |
| multi layer ext flag | u(1) |
| if( range_ext_flag ) | |
| sps_range_extension( ) | |
| if( multi layer ext flag ) | |
| sps my extension( ) | |
| } | |

According to another alternative example, video encoder 20 may define a number of extensions (e.g., multiple extensions), in accordance with one or more aspects of this disclosure. Such an alternative implementation by video encoder 20 is shown in Table 3D below.

TABLE 3D
Multiple Extensions Defined

| sps_extension( ) { | Descriptor |
|---|---|
| num parallel extensions minus1 | u(4) |
| [symbol] | |
| [symbol] | [symbol] |
| [symbol] | |
| [symbol] | |
| [symbol] } | |
| } | |

Changes introduced to existing SPS syntax by the alternative of Table 3D are distinguished using the font formatting scheme described above with respect to Tables 3A-3C. Additional changes introduced by the alternative implementation of Table 3D are distinguished using single-dashed-line underlining. Semantics associated with the syntax of Table 3D are described below, to describe implementation of this alternative by video encoder 20.

Video encoder 20 may use the value of the num_parallel_extensions_minus1 syntax element, plus 1, to specify the number of SPS sub extensions present in the sps_extension( ) syntax structure. In various alternatives, video encoder 20 may signal the num_parallel_extensions_minus1 syntax element with u(2), u(3), or any fixed value of u(N). In one alternative, video encoder 20 may signal this syntax element with ue(v).

The sps_sub_extension_table(i) syntax structure is registered by each parallel extension of HEVC supported by video encoder 20 according to aspects of this disclosure. For example, may associate the sps_sub_extension_table(0) syntax structure with the sps_range_extension( ) syntax structure, and may associate the sps_sub_extension_table(1) structure with the sps_mv_extension( ) syntax structure. In one example, video encoder 20 may associate the sps_sub_extension_table(2) syntax structure with the SPS HEVC extension. Alternatively, according to this example, video encoder 20 may provide further extensions as indicated by the sps_futher_extension_flag syntax element and the sps_further_extension_data_flag syntax element.

Changes introduced by this example implementation to the existing syntax of the range extension SPS are described in Table 4 below. The changes introduced by this example implementation are distinguished using the font formatting scheme described above with respect to Tables 3A-3D. The changes introduced to the semantics associated with the syntax of Table 4 are described below Table 4.

TABLE 4
Range Extension SPS Syntax

| sps_range_extension( ) { | |
|---|---|
| transform_skip_rotation_enabled_flag | u(1) |
| transform_skip_context_enabled_flag | u(1) |
| intra_block_copy_enabled_flag | u(1) |
| residual_dpcm_intra_enabled_flag | u(1) |
| residual_dpcm_inter_enabled_flag | u(1) |
| extended_precision_processing_flag | u(1) |
| intra_smoothing_disabled_flag | u(1) |
| sps_range_extension2_flag | u(1) |
| if(sps_range_extension2_flag ) | |
| while( more_rbsp_data( ) ) | |
| sps_range_extension_data_flag | u(1) |
| } | |

Video encoder 20 may set the sps_range_extension2_flag syntax element equal to 0 to specify that no sps_range_extension_data_flag syntax elements are present in the SPS RBSP syntax structure. In cases where the sps_range_extension2_flag syntax element is present, video encoder 20 may set the sps_range_extension_data_flag syntax element equal to 0 in an encoded video bitstream, in accordance with Example Implementation #1. In cases where the sps_range_extension2_flag syntax element is not present, video encoder 20 may infer the value of the sps_range_extension_data_flag syntax element to be equal to 0. The value of 1 for sps_range_extension_data_flag is reserved for future use by ITU-T|ISO/IEC. Video decoding devices, such as video decoder 30, if configured to operate according to ExampleDecoders, may allow the value of the sps_range_extension_data_flag syntax element (if present) to be equal to 1, and may ignore all sps_range_extension_data_flag syntax elements that follow the value of 1 for the sps_range_extension2_flag syntax element in a given SPS NAL unit.

Video encoder 20 may set the sps_range_extension_data_flag syntax element to any value. According to Example Implementation #1 described herein, the presence/absence and/or the value of the sps_range_extension_data_flag syntax element do not affect decoder conformance to the features of Example Implementation #1. Decoding devices, such as video decoder 30, if configured to conform to Example Implementation #1, may ignore all sps_range_extension_data_flag syntax elements.

Changes introduced by to the existing syntax of the MV-HEVC extension SPS are described in Table 5 below. The changes introduced by this example implementation are distinguished using the font formatting scheme described above with respect to Tables 3A-3D and 4. The changes introduced to the semantics associated with the syntax of Table 5 are described below Table 5.

TABLE 5
MV-HEVC Extension SPS Syntax

| sps my extension ( ) { | |
|---|---|
| inter view my vert constraint flag | u(1) |
| sps shvc reserved zero idc | ue(v) |
| sps my extension2 flag | u(1) |
| if(sps my extension2 flag ) | |
| while( more rbsp data( ) ) | |
| sps my extension data flag | u(1) |
| { | |

Video encoder 20 may set the sps_mv_extension2_flag syntax element equal to 0 to specify that no sps_mv_extension_data_flag syntax elements are present in the SPS RBSP syntax structure. In instances where one or more sps_mv_extension_data_flag syntax elements are present in the SPS RBSP syntax structure, video encoder 20 may set the value of the sps_mv_extension_data_flag syntax element to 0, in encoded video bitstreams conforming to various aspects of this example implementation. In instances where no sps_mv_extension_data_flag syntax elements are present, video encoder 20 may infer the value of the sps_mv_extension_data_flag syntax element to be equal to 0. The value of 1 for sps_mv_extension_data_flag is reserved for future use by ITU-T|ISO/IEC. Decoding devices, such as video decoder 30, if configured according to the features of this example implementation, may allow the value of the sps_mv_extension_data_flag syntax element to be equal to 1 (if the sps_mv_extension_data_flag syntax element is present), and may ignore all sps_mv_extension_data_flag syntax elements that follow the value of 1 for sps_mv_extension2_flag in a given SPS NAL unit.

Video encoder 20 may set the sps_mv_extension_data_flag syntax element to any value. The presence/absence and/or the value of the sps_mv_extension_data_flag syntax element do not affect decoder conformance to the features of this example implementation. Decoding devices, such as video decoder 30, if configured to conform to the features of this example implementation, may ignore all sps_mv_extension_data_flag syntax elements.

According to this example implementation, and in accordance with the specification of the SHVC extension, video encoder 20 may use the sps_mv_extension2_flag syntax element to extend the following syntax elements (described in Table 6 below) specifically for SHVC.

TABLE 6
SHVC SPS Syntax That May Be Extended
Using The sps_mv_extension2_flag

| for( i = 0; i < num_scaled_ref_layer_offsets; i++) { | |
|---|---|
| scaled_ref_layer_left_offset[ i ] | se(v) |
| scaled_ref_layer_top_offset[ i ] | se(v) |
| scaled_ref_layer_right_offset[ i ] | se(v) |
| scaled_ref_layer_bottom_offset[ i ] | se(v) |
| } | |

In an alternative example, with respect to SHVC, video encoder 20 may not include the sps_shvc_reserved_zero_idc syntax element is not present in the sps_mv_extension( ) syntax structure.

In some scenarios, video decoder 30 is an example of a non-transitory computer-readable storage medium encoded with instructions. The instructions, when executed, cause one or more processors of a video coding device to receive encoded video data representing a parameter set, and to receive, in the encoded video data, a syntax element indicating whether the parameter set includes two or more extension syntax structures. The instructions, when executed may further cause the processor(s) of the video coding device to receive, in the case that the syntax element indicates that the parameter set includes the two or more extension syntax structures, a corresponding syntax element for each of two or more corresponding coding modes, where the corresponding syntax element indicates whether or not the parameter set includes a respective extension syntax structure for the corresponding coding mode, and to decode the encoded video data corresponding to the parameter set.

In some scenarios, video decoder 30 is an example of an apparatus for coding video data. The apparatus includes means for receiving encoded video data representing a parameter set, and means for receiving, in the encoded video data, a syntax element indicating whether the parameter set includes two or more extension syntax structures. The apparatus may further include means for receiving, in the case that the syntax element indicates that the parameter set includes the two or more extension syntax structures, a corresponding syntax element for each of two or more corresponding coding modes, where the corresponding syntax element indicates whether or not the parameter set includes a respective extension syntax structure for the corresponding coding mode, and means for decoding the encoded video data corresponding to the parameter set.

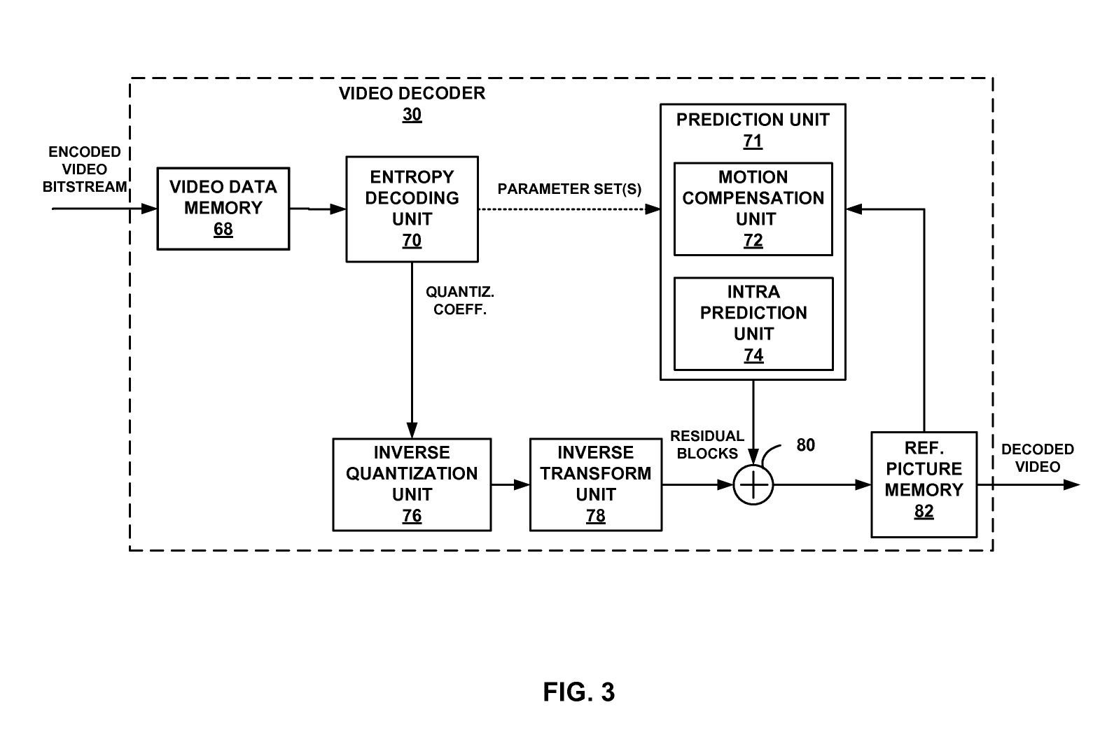

FIG. 3 is a block diagram illustrating an example of video decoder 30 that may implement techniques for decoding video data, in accordance with one or more aspects of this disclosure. For instance, video encoder 30 and components thereof, as illustrated in FIG. 3, may be configured or otherwise operable to implement or otherwise utilize one or more of the parallel extension-based techniques of this disclosure. In the example of FIG. 3, video decoder 30 includes a video data memory 68, an entropy decoding unit 70, motion compensation unit 72, intra prediction unit 74, inverse quantization unit 76, inverse transform unit 78, summer 80, and reference picture memory 82. In the example of FIG. 2, video decoder 30 includes prediction unit 71, which, in turn, includes motion compensation unit 72 and intra prediction unit 74. Video decoder 30 may, in some examples, perform a decoding pass generally reciprocal to the encoding pass described with respect to video encoder 20 (FIG. 2). Motion compensation unit 72 may generate prediction data based on motion vectors received from entropy decoding unit 70, while intra prediction unit 74 may generate prediction data based on intra-prediction mode indicators received from entropy decoding unit 70.

Video data memory 68 may store video data, such as an encoded video bitstream, to be decoded by the components of video decoder 30. The video data stored in video data memory 68 may be obtained, for example, from computer-readable medium 16 and/or storage device 31, e.g., from a local video source, such as a camera, via wired or wireless network communication of video data, or by accessing physical data storage media. Video data memory 68 may form a coded picture buffer (CPB) that stores encoded video data from an encoded video bitstream. Video data memory 68 may be a reference picture memory that stores reference video data for use in decoding video data by video decoder 30, e.g., in intra- or inter-coding modes. Video data memory 68 and decoded picture buffer 162 may be formed by any of a variety of memory devices, such as dynamic random access memory (DRAM), including synchronous DRAM (SDRAM), magnetoresistive RAM (MRAM), resistive RAM (RRAM), or other types of memory devices. Video data memory 68 may be provided by the same memory device or separate memory devices. In various examples, video data memory 68 may be on-chip with other components of video decoder 30, or off-chip relative to those components.

During the decoding process, video decoder 30 receives an encoded video bitstream that represents video blocks of an encoded video slice and associated syntax elements from video encoder 20. Entropy decoding unit 70 of video decoder 30 entropy decodes the bitstream to generate quantized coefficients, motion vectors or intra-prediction mode indicators, and other syntax elements. Entropy decoding unit 70 forwards the motion vectors and other syntax elements to motion compensation unit 72. Video decoder 30 may receive the syntax elements at the video slice level and/or the video block level.

When the video slice is coded as an intra-coded (I) slice, intra prediction unit 74 may generate prediction data for a video block of the current video slice based on a signaled intra prediction mode and data from previously decoded blocks of the current frame or picture. When the video frame is coded as an inter-coded (i.e., B, P or GPB) slice, motion compensation unit 72 produces predictive blocks for a video block of the current video slice based on the motion vectors and other syntax elements received from entropy decoding unit 70. The predictive blocks may be produced from one of the reference pictures within one of the reference picture lists. Video decoder 30 may construct the reference frame lists, List 0 and List 1, using default construction techniques based on reference pictures stored in reference picture memory 82.

Motion compensation unit 72 determines prediction information for a video block of the current video slice by parsing the motion vectors and other syntax elements, and uses the prediction information to produce the predictive blocks for the current video block being decoded. For example, motion compensation unit 72 uses some of the received syntax elements to determine a prediction mode (e.g., intra- or inter-prediction) used to code the video blocks of the video slice, an inter-prediction slice type (e.g., B slice, P slice, or GPB slice), construction information for one or more of the reference picture lists for the slice, motion vectors for each inter-encoded video block of the slice, inter-prediction status for each inter-coded video block of the slice, and other information to decode the video blocks in the current video slice.

Motion compensation unit 72 may also perform interpolation based on interpolation filters. Motion compensation unit 72 may use interpolation filters as used by video encoder 20 during encoding of the video blocks to calculate interpolated values for sub-integer pixels of reference blocks. In this case, motion compensation unit 72 may determine the interpolation filters used by video encoder 20 from the received syntax elements and use the interpolation filters to produce predictive blocks.

Inverse quantization unit 76 inverse quantizes, i.e., de quantizes, the quantized transform coefficients provided in the bitstream and decoded by entropy decoding unit 70. The inverse quantization process may include use of a quantization parameter QPY calculated by video decoder 30 for each video block in the video slice to determine a degree of quantization and, likewise, a degree of inverse quantization that should be applied.

Inverse transform unit 78 applies an inverse transform, e.g., an inverse DCT, an inverse integer transform, or a conceptually similar inverse transform process, to the transform coefficients in order to produce residual blocks in the pixel domain.

After motion compensation unit 72 generates the predictive block for the current video block based on the motion vectors and other syntax elements, video decoder 30 forms a decoded video block by summing the residual blocks from inverse transform unit 78 with the corresponding predictive blocks generated by motion compensation unit 72. Summer 80 represents the component or components that perform this summation operation. If desired, a deblocking filter may also be applied to filter the decoded blocks in order to remove blockiness artifacts. Other loop filters (either in the coding loop or after the coding loop) may also be used to smooth pixel transitions, or otherwise improve the video quality. The decoded video blocks in a given frame or picture are then stored in reference picture memory 82, which stores reference pictures used for subsequent motion compensation. Reference picture memory 82 also stores decoded video for later presentation on a display device, such as display device 32 of FIG. 1.

Video decoder 30 (and/or various components thereof, such as entropy decoding unit 70), may be configured to implement various techniques of this disclosure to support parallel extensions for parameter sets. In various examples, video decoder 30 may implement reciprocal operations to those described herein with respect to video encoder 20 and/or various components thereof. For instance, video decoder 30 may decode a given parameter set in such a way that any parameter set extension syntax structures defined by the range extension to HEVC are processed as being parallel extensions to one or both of parameter set extension syntax structures defined by MV-HEVC or SHVC extensions. In other words, in one example, video decoder 30 may decode parameter set extension syntax structures defined by MV-HEVC independently of decoding parameter set extension syntax structures defined by the range extension, with respect to a given parameter set.

For ease of discussion purposes only, the techniques are described in the following paragraphs with respect to video decoder 30 supporting range extension-defined and MV-HEVC-defined parameter set extension syntax structures as parallel parameter set extension syntax structures. However, it will be understood that, in accordance with aspects of this disclosure, video decoder 30 may also parameter set extension syntax structures defined by the range extension and SHVC as parallel parameter set extensions. By implementing the techniques described herein, video decoder 30 may reduce computing resource consumption by decoupling parameter set extension syntax structures defined by MV-HEVC from parameter set extension syntax structures defined by the range extension, with respect to a single parameter set.

According to the techniques of this disclosure, video decoder 30 may be configured to support multiple parameter set extensions defined by the range extension and MV-HEVC in parallel, even if each of the range extension and MV-HEVC is built directly on top of HEVC. In other words, video decoder 30 may support parallel parameter set extensions in accordance with the techniques described herein, regardless of whether MV-HEVC is implemented as a direct extension of HEVC, or as a further extension of the range extension.

Video decoder 30 may implement the techniques described herein by reading one or more extension flags included in the encoded video bitstream signaled by video encoder 20. Examples of extension flags that video decoder 30 may read to support the multiple parallel extensions according to the techniques described herein include an sps_extension_flag and/or a pps_extension_flag, and optionally, one or more of a range_ext_flag, a multi_layer_ext_flag, or an sps_mv_extension2_flag.

More specifically, video decoder 30 may read the sps_extension_flag or the pps_extension_flag to obtain an indication of whether or not a particular encoded parameter set (e.g., an SPS or PPS, respectively) includes any extension parameter sets at all. For example, if video decoder 30 determines that an instance of an sps_extension_flag is set to a “true” value (e.g., a value of one), then video decoder 30 may determine that the corresponding SPS includes one or more extension syntax structures. In this example, video decoder 30 may use the sps_extension_flag value of one to determine only that the SPS includes at least one extension syntax structure, but not to determine which HEVC extension defines each included extension syntax structure.

In turn, based on determining that the SPS includes one or more extension syntax structures, video decoder 30 may use additional flags to determine which HEVC extension(s) may define each extension syntax structure included in the SPS. For example, upon determining that the sps_extension_flag is set to a value of one, video decoder 30 may read the value of one or more of the following syntax elements: the range_ext_flag, the multi_layer_ext_flag, or the sps_mv_extension2_flag.

If video decoder 30 determines that the range_ext_flag is set to a “true” value (e.g., a value of one), then video decoder 30 may determine that the SPS includes at least one extension syntax structure defined by the range extension to HEVC. If video decoder 30 reads the range_ext_flag as having a value of one, then video decoder 30 may determine that the SPS includes one or more extension structures defined by the range extension to HEVC. Similarly, if video decoder 30 reads the multi_layer_ext_flag as having a value of one, then video decoder 30 may determine that the SPS includes one or more extension structures defined by MV-HEVC.

In turn, if video decoder 30 determines that the SPS includes extension syntax structures defined by one or both of the range extension or MV-HEVC, video decoder 30 may decode the SPS by decoding any included extension structure(s) as well. By supporting multiple parameter set extensions (e.g., extension syntax structures defined by the range extension and MV-HEVC) according to the techniques of this disclosure, video decoder 30 may conserve computing resources and improve processing efficiency, while potentially reducing the signaling and processing requirements placed on video encoder 20.

One example of these potential advantages is illustrated in a scenario where video decoder 30 determines that the range_ext_flag has a value of zero, and that the multi_layer_ext_flag has a value of one. In this example, upon determining that the range_ext_flag is false (based on the zero value), video decoder 30 may determine that the corresponding parameter set does not include any extension syntax structures defined by the range extension to HEVC. In turn, upon determining that the multi_layer_ext_flag is true (based on the value of one), video decoder 30 may proceed to decode one or more MV-HEVC-defined extension syntax structures included in the parameter set. Thus, video decoder 30 may implement techniques of this disclosure to decouple parameter set extension syntax structures defined by MV-HEVC from parameter set extension syntax structures defined by the range extension to HEVC. In this manner, video decoder 30 may implement the techniques of this disclosure to decode MV-HEVC-defined extension syntax structures independently of any range extension-defined extension syntax structures of the same parameter set.

Additionally, in accordance with various aspects of this disclosure, video decoder 30 may support parallel parameter set extension syntax structures in a variety of manners. In some examples, video decoder 30 may support a fixed number of HEVC extensions that define the parallel extension syntax structures for a given parameter set. In the examples above, video decoder 30 supports parallel parameter set extensions defined by two HEVC extensions, namely the range extension and MV-HEVC. In some examples, video decoder 30 may read, in decoding the encoded video bitstream, the number of HEVC extensions that can define parallel parameter set extension syntax structures supported with respect to a given parameter set. In these examples, the number of HEVC extensions according to which video decoder 30 supports parallel parameter set extension syntax is the same as a fixed number of parallel extensions defined by video encoder 20 for the parameter set.

Thus, video decoder 30 is an example of a device for coding video data. In this example, the device includes a memory and one or more processors. The processor(s) may be configured to receive encoded video data representing a parameter set, and to receive, in the encoded video data, a syntax element indicating whether the parameter set includes two or more extension syntax structures. The processor(s) may be further configured to, in the case that the syntax element indicates that the parameter set includes the two or more extension syntax structures, receive a corresponding syntax element for each of two or more corresponding coding modes, where the corresponding syntax element indicates whether or not the parameter set includes a respective extension syntax structure for the corresponding coding mode, and to decode the encoded video data corresponding to the parameter set.

In some examples, the parameter set includes at least two extension syntax structures, and, to receive the corresponding syntax element for each of two or more corresponding coding modes, the two or more processors are configured to receive a first syntax element indicating whether or not the parameter set includes the respective extension syntax structure for a range extension coding mode, and to receive a second syntax element indicating whether or not the parameter set includes the respective extension syntax structure for a multiview extension coding mode. In some examples, to decode the parameter set, the two or more processors are configured to perform at least two of decoding the respective extension syntax structure for the range extension coding mode, or decoding the respective extension syntax for the multiview extension the coding mode.

In some examples, to decode the respective extension syntax structure for the multiview extension coding mode, the one or more processors are configured to decode the respective extension syntax structure for the multiview extension independently of decoding the respective extension syntax structure for the range extension coding mode. In some examples, the parameter set comprises a sequence parameter set (SPS) associated with a sequence of pictures encoded in the video data. In some examples, the parameter set comprises a picture parameter set (PPS) associated with a picture encoded in the video data. In some examples, the one or more processors are further configured to receive, in the encoded video data, an indication of a number of supported extension coding modes, wherein, to decode the encoded video data, the one or more processors are configured to obtain the number of supported coding modes. In some examples, the number of supported coding modes is two (2).

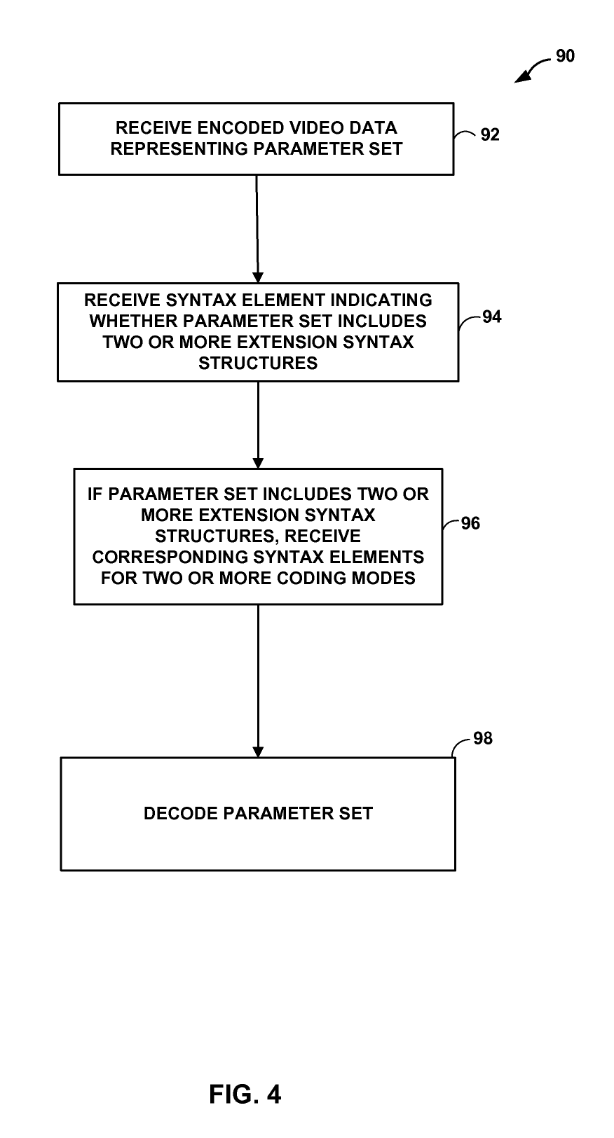

FIG. 4 is a flowchart illustrating an example process 90 that video decoder 30 may perform to support multiple parameter set extensions in parallel, in accordance with one or more aspects of this disclosure. More specifically, as described above, video decoder 30 may support parallel parameter set extensions that are defined by different HEVC extensions (e.g., the range extension and MV-HEVC). While various steps of process 90 may be performed by various components of video decoder 30 (e.g., as illustrated in FIG. 3), for ease of discussion purposes only, process 90 is described herein as being performed by video decoder 30. Additionally, while the steps of process 90 are illustrated and described in one particular order as an example, it will be appreciated that video decoder 30 may perform the steps of process 90 in various sequences or orders, including performing two or more steps (at least partially) at once.

Process 90 may begin with video decoder 30 receiving encoded video data representing a parameter set (92). For instance, video decoder 30 may receive the encoded parameter set as part of an encoded video bitstream signaled by video encoder 20. In various scenarios, the parameter set may be either a sequence parameter set (SPS) or a picture parameter set (PPS). Additionally, video decoder 30 may receive a syntax element indicating whether the parameter set includes two or more extension syntax structures (94). For instance, video decoder 30 may receive a parameter set extension flag that indicates whether the parameter set includes the two or more extension syntax structures. Video decoder 30 may associate an sps_extension_flag with an SPS, and a pps_extension_flag with a particular PPS.

Additionally, if the parameter set includes two or more extension syntax structures, video decoder 30 may receive corresponding one or more syntax elements for one or more coding modes (96). The corresponding syntax elements may indicate whether or not the parameter set includes a respective extension syntax structure for the corresponding coding mode. As examples, the corresponding syntax elements may be dedicated flags, indicating particular coding modes, such as a range extension coding mode or multiview extension coding mode. For example, if video decoder 30 reads a parameter set extension flag as being “true,” video decoder 30 may determine that the parameter set includes at least one parameter set extension syntax structure. In turn, video decoder 30 may receive one or both of a range_ext_flag or a multiview_ext_flag, indicating the presence of parameter set extension syntax structures of a range extension coding mode or a multiview extension coding mode, respectively.

Additionally, video decoder 30 may decode the parameter set (98). For instance, if the parameter set includes any extension syntax structure(s), video decoder 30 may also decode the extension syntax structures, as indicated by the parameter set extension flag and one or more dedicated flags for particular coding modes. Conversely, if the parameter set does not include any extension syntax structures, video decoder 30 may decode the unextended parameter set.

Thus, video decoder 30, in some examples, may perform a method of decoding video data, the method including receiving encoded video data representing a parameter set, and receiving, in the encoded video data, a syntax element indicating whether the parameter set includes two or more extension syntax structures. The method may further include, in the case that the syntax element indicates that the parameter set includes the two or more extension syntax structures, receiving a corresponding syntax element for each of two or more corresponding coding modes, where the corresponding syntax element indicates whether or not the parameter set includes a respective extension syntax structure for the corresponding coding mode, and decoding the encoded video data corresponding to the parameter set.

In some examples, the parameter set includes at least two extension syntax structures, and receiving the corresponding syntax element for each of the two or more corresponding coding modes comprises receiving a first syntax element indicating whether or not the parameter set includes the respective extension syntax structure for a range extension coding mode, and receiving a second syntax element indicating whether or not the parameter set includes the respective extension syntax structure for a multiview extension coding mode. In some examples, decoding the parameter set comprises performing at least one of decoding the respective extension syntax structure for the range extension coding mode, or decoding the respective extension syntax for the multiview extension the coding mode.

In some examples, decoding the respective extension syntax structure for the multiview extension coding mode comprises decoding the respective extension syntax structure for the multiview extension independently of decoding the respective extension syntax structure for the range extension coding mode. In some examples, the parameter set comprises a sequence parameter set (SPS) associated with a sequence of pictures encoded in the video data. In some examples, the parameter set comprises a picture parameter set (PPS) associated with a picture encoded in the video data. In some examples, the method further includes receiving, in the encoded video data, an indication of a number of supported extension coding modes, where decoding the encoded video data comprises obtaining the number of supported coding modes. In some examples, the number of supported coding modes is two (2).

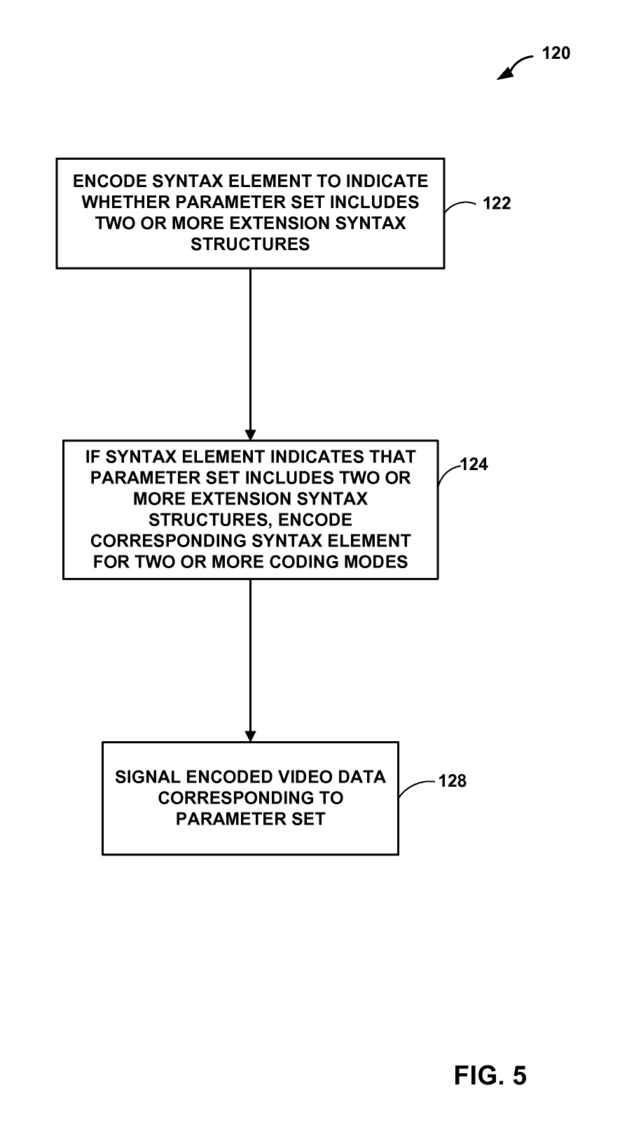

FIG. 5 is a flowchart illustrating example process 120 that video encoder 20 may perform to support multiple parameter set extensions in parallel, in accordance with one or more aspects of this disclosure. While various steps of process 120 may be performed by various components of video encoder 20 (e.g., as illustrated in FIG. 2), for ease of discussion purposes only, process 120 is described herein as being performed by video encoder 20. Additionally, while the steps of process 120 are illustrated and described in one particular order as an example, it will be appreciated that video encoder 20 may perform the steps of process 120 in various sequences or orders, including performing two or more steps (at least partially) at once.

Process 120 may begin with video encoder 20 encoding a syntax element to indicate whether a parameter set includes two or more extension syntax structures (122). For example, video encoder 20 may encode the parameter set extension flag to indicate whether or not the parameter set includes any extension syntax structures. The parameter set may be a sequence parameter set (SPS) or a picture parameter set (PPS) in various examples. If video encoder 20 determines that the parameter set includes any extension syntax structures video encoder 20 may set a parameter set extension flag to indicate a “false” state, such as by setting the parameter set extension flag to a value of zero. However, if video encoder 20 determines that the parameter set includes at least one extension syntax structure, video encoder 20 may set a parameter set extension flag to a “true” state, such as by setting the parameter set extension flag to a value of one. At steps 125 and 128, video encoder 20 may use an instance of the extension flag that is associated with the current parameter set. Additionally, video encoder 20 may use a single instance of an sps_extension_flag for a particular SPS, and a single instance of a pps_extension_flag for a particular PPS.

If the syntax element indicates that the parameter set includes the two or more extension syntax structures, video encoder 20 may encode one or more corresponding syntax elements for two or more coding modes (124). The corresponding syntax elements may be dedicated flags. For instance, if the parameter set includes at least one extension syntax structure defined by the range extension coding mode, video encoder 20 may set a range_ext_flag to a true state (e.g., a value of one) for the parameter set. Similarly, if the parameter set includes at least one extension syntax structure defined by a multiview extension coding mode, video encoder 20 may set a multi_layer_ext_flag to a true state (e.g., a value of one) for the parameter set. In some cases where the multi_layer_ext_flag is set to true, video encoder 20 may also determine whether the parameter set includes any extension syntax structures defined by SHVC, and if so, may set a dedicated flag for SHVC-defined extension syntax to true.

Additionally, video encoder 20 may signal encoded video data corresponding to the parameter set (128). As one example, video encoder 20 may signal the encoded video data in an encoded video bitstream. For instance, in cases where the parameter set includes any parameter set extension syntax structures, video encoder 20 may signal encoded video data corresponding to the parameter set extensions as well (e.g., to signal an encoded representation of the extended parameter set). Conversely, in cases where the parameter set does not include any parameter set extension syntax structures, video encoder 20 may signal encoded video data corresponding to the unextended parameter set.

Thus, video encoder 20 may perform a method of encoding video data, the method comprising encoding a syntax element to indicate whether a parameter set includes two or more extension syntax structures, and in the case that the syntax element indicates that the parameter set includes the two or more extension syntax structures, encoding a corresponding syntax element for each of two or more corresponding coding modes, where the corresponding syntax element indicates whether or not the parameter set includes a respective extension syntax structure for the corresponding coding mode. The method further includes signaling encoded video data corresponding to the parameter set in an encoded video bitstream.

In some examples, the parameter set includes at least two extension syntax structures, where encoding the corresponding syntax element for each of the two or more corresponding coding modes comprises encoding a first syntax element indicating whether or not the parameter set includes the respective extension syntax structure for a range extension coding mode, and encoding a second syntax element indicating whether or not the parameter set includes the respective extension syntax structure for a multiview extension coding mode. In some examples, the method further comprises performing at least one of encoding the respective extension syntax structure for the range extension coding mode, or encoding the respective extension syntax for the multiview extension the coding mode. In some examples, encoding the respective extension syntax structure for the multiview extension coding mode comprises encoding the respective extension syntax structure for the multiview extension independently of encoding the respective extension syntax structure for the range extension coding mode.

In some examples, the parameter set comprises a sequence parameter set (SPS) associated with a sequence of pictures encoded in the video data. In some examples, the parameter set comprises a picture parameter set (PPS) associated with a picture encoded in the video data. In some examples, the method further comprises encoding, as part of the encoded video data, an indication of a number of supported coding modes. In some examples, the number of supported coding modes is two (2).

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium. As used herein, the term ‘signaling’ may include storing or otherwise including data with an encoded bitstream. In other words, in various examples in accordance with this disclosure, the term ‘signaling’ may be associated with real-time communication of data, or alternatively, communication that is not performed in real-time.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of decoding video data, the method comprising:
receiving encoded video data representing a parameter set;
receiving, in the encoded video data, a syntax element indicating whether the parameter set includes two or more extension syntax structures;
in the case that the syntax element indicates that the parameter set includes the two or more extension syntax structures, receiving a corresponding syntax element for each of two or more corresponding coding modes, wherein the corresponding syntax element indicates whether or not the parameter set includes a respective extension syntax structure for the corresponding coding mode; and
decoding the encoded video data corresponding to the parameter set.

2. The method of claim 1,
wherein the parameter set includes at least two extension syntax structures, and
wherein receiving the corresponding syntax element for each of the two or more corresponding coding modes comprises receiving a first syntax element indicating whether or not the parameter set includes the respective extension syntax structure for a range extension coding mode, and receiving a second syntax element indicating whether or not the parameter set includes the respective extension syntax structure for a multiview extension coding mode.

3. The method of claim 2, wherein decoding the parameter set comprises performing at least one of decoding the respective extension syntax structure for the range extension coding mode, or decoding the respective extension syntax for the multiview extension the coding mode.

4. The method of claim 3, wherein decoding the respective extension syntax structure for the multiview extension coding mode comprises:
decoding the respective extension syntax structure for the multiview extension independently of decoding the respective extension syntax structure for the range extension coding mode.

5. The method of claim 1, wherein the parameter set comprises a sequence parameter set (SPS) associated with a sequence of pictures encoded in the video data.

6. The method of claim 1, wherein the parameter set comprises a picture parameter set (PPS) associated with a picture encoded in the video data.

7. The method of claim 1, further comprising:
receiving, in the encoded video data, an indication of a number of supported extension coding modes,
wherein decoding the encoded video data comprises obtaining the number of supported coding modes.

8. The method of claim 7, wherein the number of supported coding modes is two (2).

9. A method of encoding video data, the method comprising:
encoding a syntax element to indicate whether a parameter set includes two or more extension syntax structures;
in the case that the syntax element indicates that the parameter set includes the two or more extension syntax structures, encoding a corresponding syntax element for each of two or more corresponding coding modes, wherein the corresponding syntax element indicates whether or not the parameter set includes a respective extension syntax structure for the corresponding coding mode;
signaling encoded video data corresponding to the parameter set in an encoded video bitstream.

10. The method of claim 9,
wherein the parameter set includes at least two extension syntax structures, and
wherein encoding the corresponding syntax element for each of the two or more corresponding coding modes comprises encoding a first syntax element indicating whether or not the parameter set includes the respective extension syntax structure for a range extension coding mode, and encoding a second syntax element indicating whether or not the parameter set includes the respective extension syntax structure for a multiview extension coding mode.

11. The method of claim 10, further comprising performing at least one of encoding the respective extension syntax structure for the range extension coding mode, or encoding the respective extension syntax for the multiview extension the coding mode.

12. The method of claim 11, wherein encoding the respective extension syntax structure for the multiview extension coding mode comprises:
encoding the respective extension syntax structure for the multiview extension independently of encoding the respective extension syntax structure for the range extension coding mode.

13. The method of claim 9, wherein the parameter set comprises a sequence parameter set (SPS) associated with a sequence of pictures encoded in the video data.

14. The method of claim 9, wherein the parameter set comprises a picture parameter set (PPS) associated with a picture encoded in the video data.

15. The method of claim 9, further comprising encoding, as part of the encoded video data, an indication of a number of supported coding modes.

16. The method of claim 15, wherein the number of supported coding modes is two (2).

17. A device for coding video data, the device comprising:
a memory; and
one or more processors configured to:
receive encoded video data representing a parameter set;
receive, in the encoded video data, a syntax element indicating whether the parameter set includes two or more extension syntax structures;
in the case that the syntax element indicates that the parameter set includes the two or more extension syntax structures, receive a corresponding syntax element for each of two or more corresponding coding modes, wherein the corresponding syntax element indicates whether or not the parameter set includes a respective extension syntax structure for the corresponding coding mode; and
decode the encoded video data corresponding to the parameter set.

18. The device of claim 17,
wherein the parameter set includes at least two extension syntax structures, and
wherein, to receive the corresponding syntax element for each of two or more corresponding coding modes, the two or more processors are configured to receive a first syntax element indicating whether or not the parameter set includes the respective extension syntax structure for a range extension coding mode, and to receive a second syntax element indicating whether or not the parameter set includes the respective extension syntax structure for a multiview extension coding mode.

19. The device of claim 18, wherein, to decode the parameter set, the two or more processors are configured to perform at least two of decoding the respective extension syntax structure for the range extension coding mode, or decoding the respective extension syntax for the multiview extension the coding mode.

20. The device of claim 19, wherein, to decode the respective extension syntax structure for the multiview extension coding mode, the one or more processors are configured to:
decode the respective extension syntax structure for the multiview extension independently of decoding the respective extension syntax structure for the range extension coding mode.

21. The device of claim 17, wherein the parameter set comprises a sequence parameter set (SPS) associated with a sequence of pictures encoded in the video data.

22. The device of claim 17, wherein the parameter set comprises a picture parameter set (PPS) associated with a picture encoded in the video data.

23. The device of claim 17, wherein the one or more processors are further configured to:
receive, in the encoded video data, an indication of a number of supported extension coding modes,
wherein, to decode the encoded video data, the one or more processors are configured to obtain the number of supported coding modes.

24. The device of claim 23, wherein the number of supported coding modes is two (2).

25. A non-transitory computer-readable storage medium encoded with instructions that, when executed, cause one or more processors of a video coding device to:
receive encoded video data representing a parameter set;
receive, in the encoded video data, a syntax element indicating whether the parameter set includes two or more extension syntax structures;
in the case that the syntax element indicates that the parameter set includes the two or more extension syntax structures, receive a corresponding syntax element for each of two or more corresponding coding modes, wherein the corresponding syntax element indicates whether or not the parameter set includes a respective extension syntax structure for the corresponding coding mode; and
decode the encoded video data corresponding to the parameter set.

26. An apparatus for coding video data, the apparatus comprising:
means for receiving encoded video data representing a parameter set;
means for receiving, in the encoded video data, a syntax element indicating whether the parameter set includes two or more extension syntax structures;
means for receiving, in the case that the syntax element indicates that the parameter set includes the two or more extension syntax structures, a corresponding syntax element for each of two or more corresponding coding modes, wherein the corresponding syntax element indicates whether or not the parameter set includes a respective extension syntax structure for the corresponding coding mode;
means for decoding the encoded video data corresponding to the parameter set.
